(19) United States
(12) Patent Application Publication
(10) Pub. No.: US 2026/0063026 A1
(43) Pub. Date: Mar. 5, 2026

(54) FLARE IMAGING

(71) Applicant: DRILLDOCS COMPANY, Houston, TX (US)

(72) Inventors: Calvin Stuart Holt, Houston, TX (US); Martin E Oehlbeck, Cochocton, NY (US); Francois Ruel, Victoriaville (CA)

(21) Appl. No.: 19/320,722

(22) Filed: Sep. 5, 2025

Related U.S. Application Data
(60) Provisional application No. 63/691,226, filed on Sep. 5, 2024.

(51) Int. Cl. E21B 44/00; E21B 7/04; E21B 47/002; E21B 49/00; G06T 7/00; G06T 7/50; G06T 7/62; G06T 7/73

(52) U.S. Cl. CPC E21B 44/00; E21B 7/04; E21B 47/002; E21B 49/00; G06T 7/0002; G06T 7/50; G06T 7/62; G06T 7/73; E21B 2200/22; G06T 2207/20084; G06T 2207/30181

(57) ABSTRACT

Detection technology to monitor a flare stack during drilling operations and determine information based on the imaging. Various actions may be taken based on the determined information. For example, subterranean geology may be mapped. This may include mapping formation properties, fractures, faults or reservoir zones. Additionally, drilling operational parameters may be adjusted. This may include adjusting rate of direction, penetration, weight on bit, rotary speed, mud flow rate, mud weight, actuating a valve, or changing the pump speed.

### BACKGROUND

During oil and gas drilling operations, flare stacks are often used to safely combust excess gases released during drilling. These gases, which can include natural gas, volatile organic compounds (VOCs), and other hydrocarbons, are routed to the flare stack to be burned off in a controlled manner. In some applications, this process inhibits the accumulation of potentially explosive gases on-site and inhibits the release of unburned hydrocarbons into the atmosphere in accordance with environmental regulations. In many drilling operations, it is desirable to monitor the flare stack to inform workers that the operation is proceeding safely, compliant with regulations, and working relatively well. For example, visual indications of flare combustion may alert inspectors to unsafe conditions, such as high pressure, ignition system failures, blockages, or leaks, which can lead to blowouts, explosions, or the release of pollutants into the atmosphere. Monitoring the flare stack during drilling operations is a useful process that ensures operational safety, environmental protection, regulatory compliance, optimized operational efficiency, and cost savings. Additionally, information regarding the productivity of regions of the wellbore may be gleaned from an astute observer of the flare stack, along with other instrumentation.

Typically, visual inspection of the flare stack operation is performed by an engineer who visually assesses flare stack conditions and makes decisions to maintain or change operational parameters based on the assessment. They may also review the flare stack conditions to make determinations about the well's productivity at various depths. This workflow is susceptible to inevitable human error, slow processing times, and incomplete information obtained by a human observer.

Due to the inherent explosive danger and the threat of environmental pollution posed by mistakes and slow decision-making, as well as the value of productivity assessments, various technologies have been employed to increase the effectiveness of flare stack monitoring. For example, cameras may be used for monitoring, allowing the engineer to view the flare stack from a remote viewing location. In some instances, these cameras may have thermal imaging capabilities, allowing the engineer to read heat outputs and distinguish temperature readings from the flare from background temperatures. Gas analyzers and flow meters may be used to report gas composition and the volume of gas being sent to the flare stack to the engineers. This vast amount of information is difficult for engineers to process quickly and efficiently, further compounding safety issues and the risk of environmental pollution. This also leads to inefficient use of information that may be obtained from flare stack monitoring.

Thus, it remains desirable to reduce human error, process data faster, and use the information received from flare stack imaging to improve overall performance of the drill operation. It is with respect to these and other considerations that the technologies described below have been developed. Also, although relatively specific problems have been discussed, it should be understood that the embodiments should not be limited to solving the specific problems identified in the introduction.

### BRIEF SUMMARY

It is to be understood that both the summary and the following detailed description are exemplary and explanatory and are intended to provide further explanation of the innovative technologies as claimed. This summary is not intended to limit the scope of the innovative technologies described herein.

The technology generally relates to improving drilling operations at a drill rig. Aspects of the technology relate to using image detection technology to monitor a flare stack during drilling operations and determine information based on the imaging. Various actions may be taken based on the determined information. For example, subterranean geology may be mapped. This may include mapping fractures, faults, or reservoir zones. Additionally, drilling operational parameters may be adjusted. This may include adjusting inclination, azimuth, rate of penetration, weight on bit, rotary speed, mud flow rate, mud weight, actuating a valve, or changing the pump speed.

Aspects of the technology include a computer-implemented method for analyzing flare stack images. The method includes receiving drill rig operational parameters including at least one of a direction, a drill depth, a fluid flow rate, a downhole pressure, and a drill pipe pressure. The method, in examples, includes receiving image data from a flare stack, analyzing the image data to determine a flare height and size, calculating an estimated volume of the flare based on at least the image data, based on at least one of a flare height, size, and estimated volume, determining a wellbore feature, and correlating the wellbore characteristic to a depth to create a map.

In examples of the method, correlating the wellbore feature includes calculating the transport delay lag between the imaged flare and the depth. In examples of the technology, calculating the transport delay lag includes determining operational drilling parameters related to the flow of gas to the flare stack. In examples of the technology, the method includes calculating and displaying wellbore productivity information based on, at least in part, the map. In examples of the technology, the method includes automatically adjusting the flow rate of gas to the surface based on at least one of a flare height, size, and estimated volume.

In aspects of the technology, the method further comprises adjusting one of a weight on bit, a rate of penetration, a fluid density, a drill speed, a mud motor, a whipstock, or a bottom hole assembly, based on the map. In examples of the technology, the method includes analyzing the image data using a deep neural network. In examples of the technology, the method includes receiving image data from a flare stack, wherein the received image data includes sensor data. In aspects of the technology, the sensor data includes acoustic data, temperature data, and/or pressure data. In examples of the technology, the method includes sending data from the map to control directional drilling and using the map to target productive gas reservoirs.

Aspects of the technology include a computer-implemented method comprising capturing an image of a flare stack, determining a wellbore feature based on the image of a flare stack, and taking an action based on the determining information operation. In examples, determining the wellbore feature based on the image of a flare stack comprises determining, by Deep Neural Network (“DNN”), an attribute based on the image of a flare stack and associating the image of a flare stack with a data stamp. In examples of the technology, determining the wellbore feature based on the image of a flare stack comprises determining positional information of at least one subterranean geological feature. Aspects of the technology further comprise using the positional information to generate a map of the at least one subterranean geological feature with depth and lateral positioning information. In examples of the technology, the positional information of the at least one subterranean geological feature is determined, at least in part, by calculating a transport delay lag time of a fluid from a position of a drill head to the flare stack.

In aspects of the technology, the at least one subterranean geological feature includes at least one of faults, folds, natural fractures, induced fractures, natural fracture networks, induced fracture networks, stratigraphic boundaries, high-pressure zones, pressure transition zones, water-bearing zones, or reservoir zones.

In examples, taking the action comprises sending instructions to change an operational parameter during well production based on the at least one subterranean geological feature.

In aspects of the technology, taking the action comprises sending instructions to change an operational parameter during wellbore drilling. In examples of the technology, the operational parameter is at least one of adjusting a rate of penetration, adjusting weight on bit, adjusting rotary speed, adjusting mud flow rate, adjusting mud weight, actuating a valve, or changing a pump speed.

In aspects of the technology the image of a flare stack comprises an image of combustion, flame, smoke, heat waves, soot, emission, pilot flame, vapor, light, gas release, oil spray, pressure release, intermittent flare, or continuous flare.

In aspects of the technology, the attribute is one of a composition of at least one gas emanating from the flare stack at the data stamp. In examples of the technology, the composition of at least one gas is one or more of methane, ethane, propane, butane, hydrogen, hydrogen sulfide, carbon dioxide, nitrogen, benzene, toluene, ethylbenzene, xylenes, methanol, and formaldehyde. In aspects of the technology, the composition of the at least one gas includes hydrogen. In examples, the composition of the at least one gas is a mixture of hydrogen and hydrocarbons. In aspects of the technology, the output of gas is determined to increase from the previous data stamp.

In aspects of the technology, the at least one subterranean geological feature is a hydrogen reservoir.

In aspects of the technology taking action includes at least one of generating an alert or an event notification.

In examples of the technology, the method includes sending control instructions to steer a drill, based on the map.

In examples of the technology, taking an action includes sending control instructions to steer a drill, based on the information.

In aspects of the technology, the instructions include an azmuithal, wherein the azmuithal directs at least a portion of the BHA towards a wellbore feature.

In aspects of the technology the map is utilized to improve post drilling activities, e.g. well completion and update drilling model.

These and various other features as well as advantages that characterize the systems and methods described herein, will be apparent from a reading of the following detailed description and a review of the associated drawings. Additional features are set forth in the description, which follows and, in part, will be apparent from the description or may be learned by practice with the technology. It is to be understood that both the summary and the following detailed description are exemplary and explanatory and are intended to provide further explanation of the innovative technologies as claimed and should not be taken as limiting.

### BRIEF DESCRIPTION OF THE DRAWINGS

Illustrative embodiments of the present invention are described in detail below with reference to the attached drawings, wherein:

FIG. 1 is an example environment in which the systems and methods described herein may operate.

FIG. 2A provides an example of a drill rig.

FIG. 2B provides an example of a flare stack.

FIG. 3 is an example block diagram of example computer architecture devices having a flare detection application according to an example of the present disclosure.

FIGS. 4A, 4B, 4C, 4D, 4E, and 4F illustrate example images of a flare stack.

FIGS. SA, 5B, 5C, 5D, and 5E illustrate example data displayed using a graphical user interface (GUI) showing positional information of various subterranean geological features or productivity information.

FIG. 6 is an example set of output instructions corresponding to an attribute determined from an image of a flare stack.

FIG. 7A is an example method of creating a map using operational parameter data and image data.

FIG. 7B is an example method of performing flare stack imaging and determining information.

FIG. 8 is an example method of determining subterranean geological features.

FIG. 9 is an example method of taking action based on, at least in part, determined information.

FIG. 10 is an example method of taking action based on, at least in part, a determined subterranean geological feature.

FIG. 11A is an example diagram of a distributed computing system in which aspects of the present invention may be practiced

FIG. 11B is one embodiment of the architecture system in which aspects of the present disclosure may be practiced.

FIG. 12 illustrates an exemplary architecture of a computing device that can be used to implement aspects of the present disclosure.

FIG. 13 is a block diagram illustrating additional physical components (e.g., hardware) of a computing device.

FIG. 14 provides a method for determining and mapping subterranean geological features.

### DETAILED DESCRIPTION

In general, the terms and phrases used herein have their art-recognized meaning, which can be found by reference to standard texts, journal references, and contexts known to those skilled in the art. The following usages are provided to clarify their specific use in the context of this description.

A “flare stack,” also known as a flare tower to one skilled in the art, is, in examples, a tall, vertical, cylindrical structure equipped with a burner system designed to combust and dispose of waste gases such as hydrocarbons, hydrogen sulfide and other volatile organic compounds (VOCs), by releasing them into the atmosphere in the form of flames and combustion products. Flare stacks are, in examples, often constructed of heat-resistant materials such as steel and are equipped with a high-velocity ignition system, gas supply lines, and safety features such as flame arrestors and automatic shutdown systems.

An “image of a flare stack” is, in examples, a digital image of a flare stack, created using various means, including digital cameras, scanners, or digital imaging sensors. The image is captured by allowing, in examples, light to reach a sensor that creates electrical signals, in aspects of the technology. It will be appreciated that light captured is not limited to visible light but may include any useful spectrum of electromagnetic radiation, including x-rays, microwaves, gamma-rays, and infrared. Such images may or may not be translated into images suitable for display to the human eye. These electrical signals are, in examples, converted into digital data using algorithms that translate analog information into digital values. An image processor may then apply various algorithms to the digital data to enhance image quality, adjust color balance, reduce noise, and perform other corrections as needed if so determined. The data is, in examples, stored on computer-readable memory, such as hard drives, solid-state drives, or memory drives. Current, formats for storing digital images include JPEG (Joint Photographic Experts Group) for compressed, high-quality images; PNG (Portable Network Graphics) for lossless compression and support for transparency; GIF (Graphics Interchange Format) for simple animations and web use; BMP (Bitmap) for uncompressed, high-quality images; TIFF (Tagged Image File Format) for professional-grade, versatile image storage; and HEIF (High Efficiency Image Format) for efficient storage with high quality. It will be appreciated that the technology described herein may be used in combination with any image storage formats now known or later developed.

“Image data” may, in examples, be data from an image of a flare stack. Additionally, image data may be data from sensors monitoring and reporting one or more of thermal radiation, flue gas composition, acoustic data, temperature data, and pressure data. In some instances, image data includes both data from an image of a flare stack and sensor data.

A “data stamp”, in examples, includes information about the environment contemporaneous (or proximate) to the moment an image of the flare stack is captured. This may include the time of day that an image of a flare stack is captured. A data stamp may, in examples, also include, but is not limited to, a timer from the start of the process, time of day, and/or time of day and date in DD/MM/YYYY format or DAY/HOURS/MINUTES/SECONDS format. The data stamp may include operational parameters of the drilling operation, such as measurement of the location of the drilling assembly, formation type, depth of the drill head, the rheology of pumping fluid, a flow rate of pumping fluid, various instrument readings from downhole measurements (including temperature, pressure, and radiation and the like).

An “attribute” may, in examples, be a physical, chemical, mechanical, or other property of the flare, flare stack, or surrounding environment at the time or proximate to the data stamp of image capture.

An “operational parameter,” in examples, includes any setting of the wellbore or drilling equipment, or any condition that is monitored during, before, or after the drilling process. These include but are not limited to inclination, azimuth, drilling rate, weight on bit (WOB), rotary speed, mud weight, flow rate of drilling fluid, temperature, pressure, torque, directional control, circulation pressure, or well control parameters.

A “gas” may, in examples, be any gas known to one skilled in the art, such as methane, ethane, propane, butane, hydrogen, hydrogen sulfide, carbon dioxide, nitrogen, benzene, toluene, ethylbenzene, xylenes, methanol, or formaldehyde.

An “alert,” in examples, is any warning or way of bringing attention to a condition that requires decision, action or monitoring in the process of oil drilling. Alerts may be communicated contemporaneously or may be logged, and may be communicated through a variety of channels, including but not limited to visual indicators, audible alarms, digital displays, computer screens, mobile devices, or email alerts.

An “event notification”, in examples, may be a system-generated or manually initiated message that communicates the occurrence of a specific event or condition during drilling operations. These notifications, in examples, provide timely and relevant information to personnel or provide digital information to computing devices. The triggering events may be pre-defined events, conditions or thresholds, or contain essential information. Events may be communicated through a variety of channels, including but not limited to visual indicators, audible alarms, digital displays, computer screens, mobile devices, or email notifications.

A “fluid,” in examples, may be any substance that is used to facilitate the drilling process or is encountered during drilling operations. Fluids serve various purposes, including lubricating the drill bit, carrying drill cuttings to the surface, maintaining pressure in the wellbore and preventing formation damage. The type of fluid may be, but not limited to, water-based mud, oil-based mud, synthetic-based mud, or foam-based fluid.

A “subterranean geological feature”, in examples, includes any geological structure or phenomenon that exists beneath the Earth's surface, characterized by physical, chemical or structural attributes. These features may include but are not limited to rock permeability (k), faults, folds, natural fractures, induced fractures, natural fracture networks, induced fracture networks, stratigraphic boundaries, high-pressure zones, pressure transition zones, water-bearing zones, or reservoir zones.

“Positional information,” in examples, includes data that describes some aspect of the position of drilling equipment. This may include data that describes the spatial location and orientation of drilling equipment, wellbore trajectories, geological formations, and other relevant features during drilling operations. This information, in examples, includes but is not limited to the depth of the drill bit, the inclination/azimuthal relative to the vertical of the wellbore, the rotational orientation of certain tools or components such as motors, rotary systems or directional drilling assemblies.

A “drill head”, in examples, may be the component at the bottom of the drill string. In operation, the drill head typically directly engages with rock formation being drilled. A drill head, in examples, often consists of a 1) cutting structure—which cuts or breaks rock formation, 2) bit body—which provides structural support and houses the cutting structure, 3) nozzles—which spray drilling fluid onto the cutting structure, 4) a connection to the bottom of the drill string, and 5) stabilizers—which may be placed above or below the drill bit to provide additional stabilization and steering capacities.

“BHA” stands for bottom hole assembly, which, in examples, is a component of a drilling rig that is located at the bottom of the drill string. The BHA includes, in examples, some or all of the bit, drill collars, stabilizers, reamers, shocks, and hole openers.

“MWD” stands for Measurement While Drilling, which, in examples, is a technique used in drilling to collect and send data to the surface in real time. MWD may be used to measure the trajectory of a well as it's being drilled, including its depth, incline, and direction. This information may be used to create a three-dimensional plot of the wellbore. This information may be included in system data, as described more fully below.

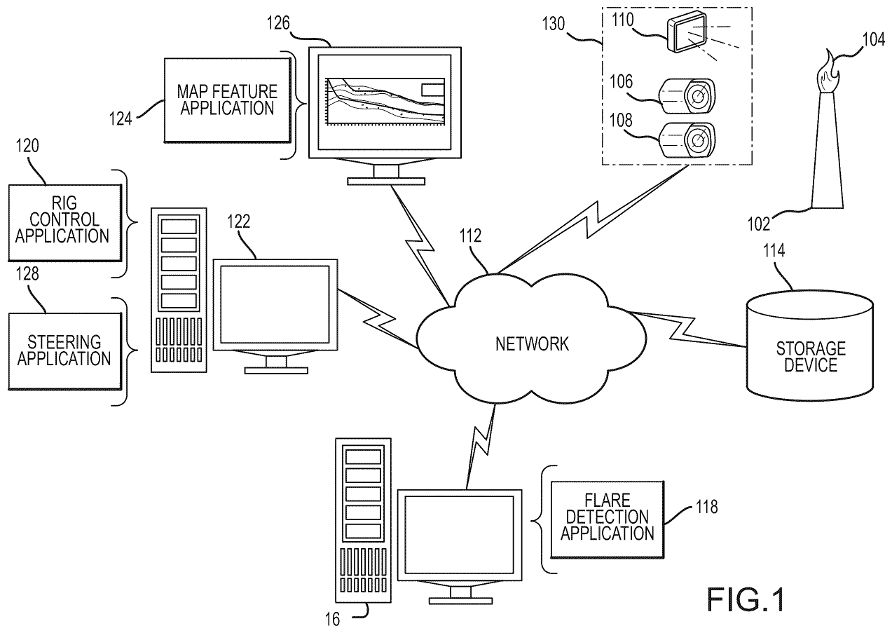

FIG. 1 is an example environment 100 in which the systems and methods described herein may operate. As illustrated, FIG. 1 includes a first computing device 116 containing a flare detection application 118, a second computing device 122 storing a rig control application 120 and a steering application 128, and a third computing device 126 with a graphical user interface (GUI) storing a map feature application 124. It will be appreciated that though the applications are shown on multiple computing devices, the applications may be run on a single computing device or more computing devices than as shown. Additionally illustrated is a storage device 114. Each of the first computing device 116, the second computing device 122, the third computing device 126, and the storage device 114 is in electronic communication via a network 112.

Flare detection application 118, in examples, receives image data from vision system 130. As illustrated, vision system 130 comprises one or more of imaging device 106 and optional second imaging device 108. Imaging devices 106 and 108 may be any device suitable to capture images of a flare stack, including a flare and/or flare stack column, such as flare 104 and flare stack column 102. Such imaging devices include charge couple device (CCD) cameras, Complementary Metal Oxide Semiconductor cameras, high-resolution cameras, visible light cameras, low light or infrared cameras, thermal imaging, and/or LiDAR imaging devices. In some applications, the vision system 130 may capture 3D profiles of flares or flare stacks using imaging devices that relate to LiDAR, stereo cameras, ultrasound sensors, or electromagnetic waves sensors, and/or other imaging devices now known or later developed capable of capturing 3D images.

Example imaging device 106 and optional second imaging device 108 include cameras that may have the following features: handheld optical gas imaging (OGI) capability for detecting a wide range of gases, including methane, hydrocarbons, CO2, and over 400 volatile organic compounds (VOCs). It may include multi-spectral filters that enable quick and accurate identification of fugitive gas emissions. The camera, in examples, is compliant with EPA OOOOa/b/c regulations, making it suitable for leak detection and repair (LDAR) activities in hazardous environments. Additionally, in examples, one or more imaging devices could support gas quantification, thermographic imaging and offer wireless connectivity for video and audio recording and streaming. The one or more imaging device, in examples, would be rugged, relatively intrinsically safe, and designed to perform reliably in relatively harsh conditions.

Also illustrated is an additional lighting source 110. In aspects, one or more additional light sources 110 illuminate aspects of a flare stack, such as flare stack column 102 and/or flare 104. A light source may be an ultraviolet light, an incandescent light, a white light, tungsten light, infrared light, or light-emitting diodes (LEDs) to illuminate flare stack column 102 and/or properties of flare 104. The light source may be capable of generating various types of light, including near, mid, or far wave infrared lights, the visible spectrum, ultraviolet light, and the like.

It will be appreciated that a single imaging device may be used to capture a large field of view from which specific regions of the flare stack may be analyzed. Image data may be of any region of the flare stack, including but not limited to one or more of any region of flare stack column 102 and flare 104.

Vision system 130 is illustrated in network communication with the various computing devices, such as a first computing device 116, second computing device 122, and third computing device 126. In aspects of the technology, vision system 130 may transmit real-time information from imaging devices. In some aspects of the technology, the image data is sent to a computing device, such as one or more of computing device 116, computing device 122, computing device 126, and storage device 114.

It will be appreciated that various ancillary devices may be employed with vision system 130 without deviating from the scope of the innovative technology. For example, various lenses, filters, enclosures, wipers, hoods, lighting, power supply, a cleaning system, brackets, and mounting devices may comprise image system 130. Further, one or more of a mechanical camera stabilizer, a camera fog stabilizer, or the like may be employed. Image system 130 may be designed to operate in outdoor, harsh, all-weather, hazardous areas, and/or 24 hours per day. The enclosure and its components may be watertight, explosion-proof, and/or intrinsically safe. This may also include a modification device that may be employed to modify, reduce, or focus the light captured from the flare stack. This includes but is not limited to infrared, visible light, and ultraviolet light. In one example, a sudden increase in flare size may require a reduction of light captured from a flare stack.

The vision system 130 may also include one or more environmental sensors. These sensors include but are not limited to one or more of sensors for monitoring and reporting of thermal radiation, flue gas composition, acoustic data, temperature data, and pressure data. These sensors may be collecting data from the environment around aflare stack or from within the flare stack. For example, a pressure sensor in the flare stack may detect a sudden increase in pressure at the time of image capture, wherein the corresponding image data determines an attribute of the flare stack as sudden increase in flare size. In other examples, vision system 130 may report a gas composition that is hydrogen.

One or more of rig control application 120, steering application 128, and map feature application 124 receive image data from flare detection application 118 as well as other data (both other data and image data are referred to herein as System 100 data). The System 100 data may include in situ data gathered from various instruments, such as sensors that measure one or more of real time sensor data related to drilling operations and/or the flare stack. System 100 data may also include other data, such as acoustic, temperature or pressure data, as well as operational parameter data, such as weight-on-bit (WOB), rate of penetration (ROP), fluid density, and drill speed. Such data may be real-time, batch data, and/or historical data. System 100 data may also include flare image data with a determined flare attribute such as a composition of at least one gas, flare size, flare height, flare volume, smoke, soot, pilot flame information, intermittent flare or continuous flare data. Using some or all of the received data, rig control application 120 may adjust one or more operational parameters, such as WOB, ROP, fluid density, flow restrictor settings, and drill speed. Using some or all of the received data, steering application 128 may adjust the lateral positioning of the wellbore for directional drilling. Flare detection application 118, rig control application 120, and/or steering application 128 may send data to map feature application 124. Using some or all of the received data from flare detection application 118 (including some or all of System 100 data), rig control application 120, and steering application 128, and/or map feature application 124 may update a current map of the subterranean geology, update formation properties, such as permeability, thickness, fractures, and/or create a new map of subterranean geology. This data may be displayed in the GUI of third computing device 126. Additionally, this data may be sent to one or more of rig control application 120 and steering application 128, which may update operational parameters or lateral positioning of the wellbore. In aspects of the technology, one or more of the image data and the updated map may be used to maintain drill position in productive areas of the well, such as areas of high gas production which, in examples, indicates higher formation permeability and porosity In certain aspects, one or more of the image data and map may be used to bring the drill position back to a productive area. In some examples, one or more of the image data and map are used for future drilling and completions, like fracturing operations to target productive areas, such as areas of high gas production. In aspects of the technology, one or more of the image data and the map are used to bypass unproductive areas in future drilling and completion operations.

The network 112 facilitates communication between various computing devices, such as the computing devices illustrated in FIG. 1. Network 112 may be the Internet, an intranet, or another wired or wireless communication network. For example, the communication network 112 may include a GLOBAL Mobile Communications (GMS) network, a code division multiple access (CDMA) network, 3^{rd} Generation Partnership Project (GPP) network, an Internet Protocol (IP) network, a wireless application protocol (WAP) network, a Wi-Fi network, a satellite communications network, or an IEEE 802.11 standards network, as well as various communications thereof. Other conventional and/or later developed wired and wireless networks may also be used.

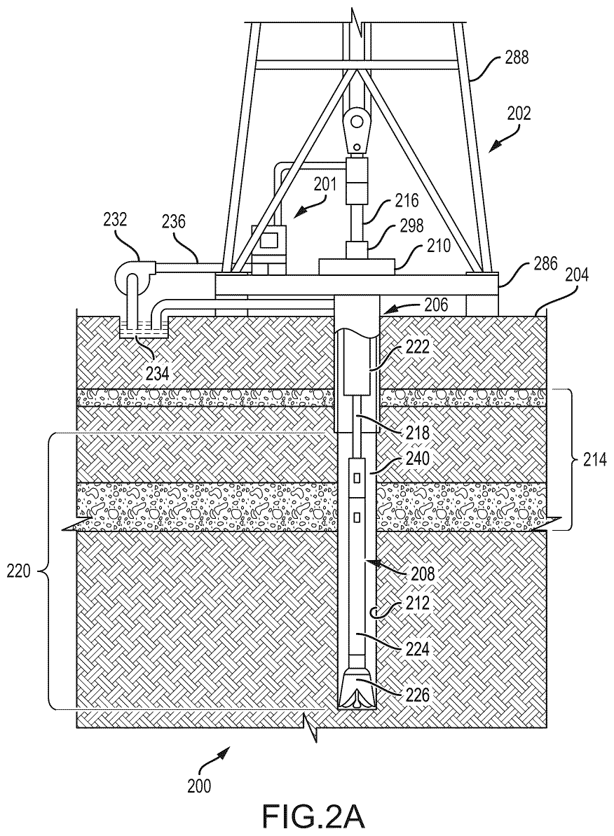

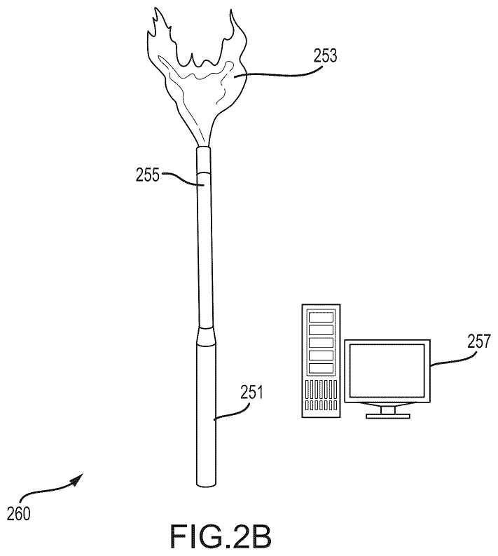

FIG. 2A provides an example of a drill rig 200, in which equipment and devices may be monitored and controlled by the various technologies described herein, including a rig control application and a wellbore stability control application. Rig 202 may be located at the surface 204 of a well 206. Drilling of oil, gas, and geothermal wells is commonly carried out using a string of drill pipes or casings connected to a drilling string 208 that is lowered through a rotary table 210 into a wellbore or borehole 212. Here, a drilling platform 286 is equipped with a derrick 288 that supports a hoist.

As illustrated, the rig 202 provides support for the drill string 208. The drill string 208 may operate to penetrate the rotary table 210 for drilling the borehole 212 through subsurface formations 214. The drill string 208 may include a Kelly 216, drill pipe 218, and a bottom hole assembly 220, perhaps located at the lower portion of the drill pipe 218.

The bottom hole assembly (BHA) 220 may include drill collars 222, a downhole tool 224, and a drill bit or float equipment 226 attached to casings for cementing. The drill bit or float equipment 226 may operate to create a borehole 212 by penetrating the surface 204 and subsurface formations 214. The downhole tool 224 may comprise any of a number of different types of tools, including MWD tools, LWD tools, casing tools and cementing tools, and others.

During drilling operations, the drill or casing string 208 (perhaps including the Kelly 216, the drill or casing pipe 218, and the bottom hole assembly 220) may be rotated by the rotary table 210. In addition to, or alternatively, the bottom hole assembly 220 may also be rotated by a motor (e.g., a mud motor) that is located down hole. The drill collars 222 may be used to add weight to the drill bit or float equipment 226.

The drill collars 222 may also operate to stiffen the bottom hole assembly 220, allowing the bottom hole assembly 220 to transfer the added weight to the drill bit and in turn, to assist the drill bit in penetrating the surface 204 and subsurface formations 214.

During drilling and pumping operations, a pump 232 may pump fluids (sometimes known by those of ordinary skill in the art as “drilling mud,” “cement,” “pills,” “spacers,” “sweeps,” “slugs”) from a processing pit 234 through a hose 236 into the drill pipe or casing 218 and down to the drill bit float equipment 226. In operation, the fluid may flow out from the drill bit or float equipment 226 and be returned to the surface 204 through an annular area 240 (e.g., an annulus) between the drill pipe or casing 218 and the sides of the wellbore borehole 212. The fluid may then be returned to the processing pit 234, where such fluid is processed (e.g., filtered). In some embodiments, the fluid can be used to cool the drill bit 226, as well as to provide lubrication for the drill bit 226 during drilling operations. Additionally, the fluid can be used to cement the wellbore and case off the sub-surface formation 214. Additionally, the fluid may be used to remove other fluid types (e.g., cement, spacers, and others), including wellbore objects such as subsurface formation 214 objects created by operating the drill bit 226 and equipment failures.

The fluid circulated down the wellbore 212 to the processing pit 234 and back down the wellbore 212 has a density. Various operational parameters of the drill rig 200 may be controlled. For example, the density of the fluid, the flow rate of the fluid, and the pressure of the wellbore 212 may be controlled. Control of the various operational parameters may be accomplished using a computing system 201, which may run/store (or be in electronic communication with) a rig control application, as described herein. The drill rig, equipment, bit, and other devices may be equipped with various sensors to monitor the operational performance of the rig, and these sensors may be in electronic communication with the computing system 201.

FIG. 2B provides an example of a flare stack 260. As illustrated, the flare stack 260 may include components such as the flare stack column 251, the flare 253, the ignition system 255, and the control system 257. The flare stack column 251 may be made of steel or any material able to withstand high temperatures and wind loads. The flare 253 may include a burner system designed to efficiently and safely combust and dispose of waste gases such as hydrocarbons, hydrogen sulfide and other volatile organic compounds (VOCs), by releasing them into the atmosphere in the form of flames and combustion products. The ignition system 255, in examples, initiates the combustion of the gases at the flare. The ignition system may include one or more of pilot burners, electronic igniters, spark igniters, and continuous pilots that ensure proper operation of the flare. In examples, control system 257 controls the operation of the flare stack 260, including the flow of gases and the ignition system 255. Such control may be facilitated by a computing system, such as computing system 201 of FIG. 2A. The control system 257 may be a computing system with one or more processors as further described herein, and may include systems and devices for controlling flare stack operations.

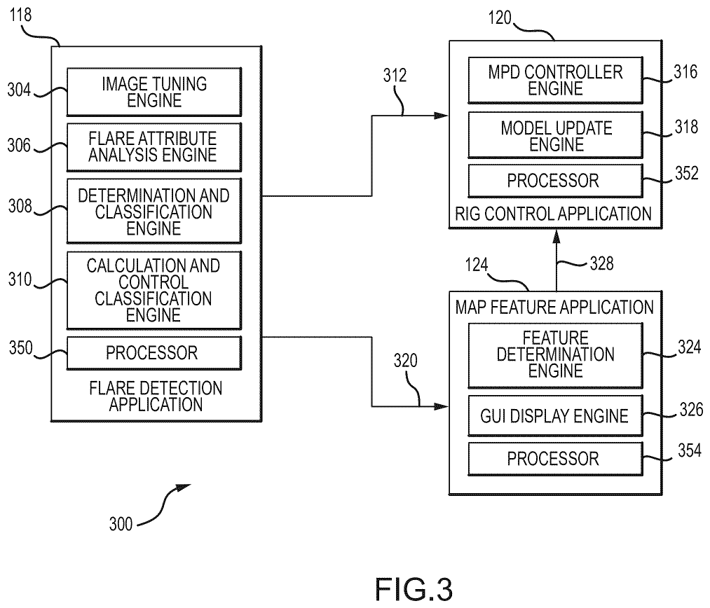

FIG. 3 is an example block diagram 300 of example computer architecture devices having a flare detection application 118 according to an example of the present disclosure. As illustrated, the flare detection application 118 uses the image of a flare stack, among other data, in examples, and determines information, which is sent to one or morx of the rig control application 120 and map feature application 124. The illustrated flare detection application 118 includes image tuning engine 304, flare attribute analysis engine 306, determination and classification engine 308, and calculation and control generation engine 310.

After the flare detection application 118 receives one or more images of a flare stack (which may include one or more images of a flare), image tuning engine 304 may be used to enhance and optimize the image of a flare stack. Enhancement techniques may include contrast adjustment, histogram equalization, and noise reduction to improve clarity. Edge sharpening and deblurring algorithms may be applied to emphasize structural features of the flare stack. Color correction and normalization may be used to account for lighting or environmental variability. In some embodiments, multi-frame averaging or super-resolution reconstruction may be employed to further optimize image fidelity for subsequent analysis. This may be referred to as “pre-processed image data.”

Flare attribute analysis engine 306 may analyze an image of a flare stack to identify one or more flare attributes. In certain examples, the analysis engine employs a deep neural network (DNN) trained with labeled flare images to perform automated classification. The DNN may include convolutional layers configured to detect spatial features such as flame edges, smoke plumes, or localized intensity gradients, and may further employ recurrent or temporal models to account for fluctuations across successive frames. In alternative examples, the analysis engine may use traditional image processing techniques such as edge detection, motion tracking, pixel intensity histograms, or spectral filtering to extract feature sets representative of flare behavior. Outputs of these models may be cross-referenced with sensor data streams (e.g., pressure, valve position, or gas flow meters) to corroborate image-based determinations and improve accuracy of operational assessments.

The flare attributes determined by analysis engine 306 may include, without limitation, flame stability (steady, pulsating, intermittent), flame intensity (normal, high, or abnormally low), flame height, flame width, and flame color. Additional attributes may encompass presence or absence of flame, occurrence of smoke plumes, sudden increases or decreases in flame size, flame intermittency patterns, and spectral signatures indicative of combustion chemistry. Thermal intensity and radiance characteristics may also be derived where infrared or multispectral imaging is employed. Each identified attribute may then be mapped to an operational determination and corresponding output instruction, such as adjusting flow rates, monitoring well pressure, or verifying ignition and gas handling systems.

Determination and classification engine 308 may be used to analyze image data to classify image data and make a determination. Determination and classification engine 308 may be used to receive attributes, such as the flare attributes identified by analysis engine 306, and analyze those attributes to classify the image data and make a determination. In some examples, the classification engine employs a deep neural network (DNN) trained with labeled flare images and associated operational data to map attributes to specific operational states. For instance, attributes such as flame size, flame color, smoke presence, or flame stability may be received from analysis engine 306 and processed through convolutional and recurrent layers of the DNN to classify the flare condition. In alternative examples, the engine may apply statistical classifiers, clustering algorithms, or support vector machines to the received attribute set in order to generate classification results.

The determination engine and classification engine 308 may associate the classified attributes with operational conclusions. For example, a received attribute of “steady flame” may be classified as normal combustion, leading to a determination of consistent gas flow and normal drilling conditions. A received attribute of “pulsating flame” may be classified as unstable combustion, leading to a determination of fluctuating pressure or flow. In other examples, determination engine 308 may correlate received attributes with time-stamped operational data, such as valve settings, flow-rate measurements, or downhole pressure logs, to refine the determination.

Calculation and control generation engine 310 may be used to perform calculations and generate control signals to be sent to rig control application 120 via communication channel 312 or map feature application 124 via communications channel 320. In some examples, calculation and control generation engine 310 receives determinations from determination and classification engine 308, along with associated attributes and operational data, and performs quantitative calculations to assess wellbore conditions. Such calculations may include estimations of gas flow rate, pressure gradients, lag time between downhole events and surface flare response, and productivity indices of subterranean reservoirs. In other examples, the engine may execute predictive models to forecast drilling performance, pressure transitions, or gas composition changes.

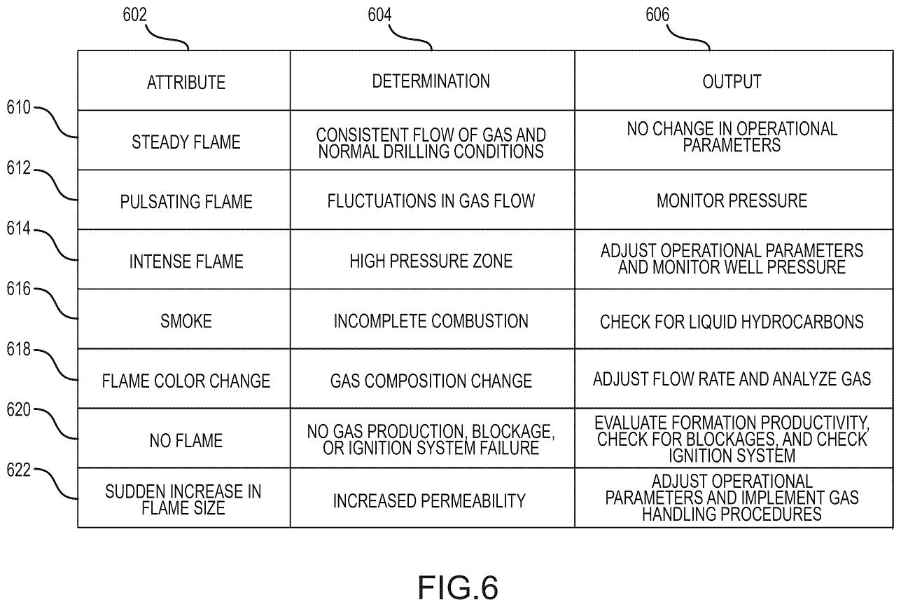

The calculation and control generation engine 310 may then translate these calculations into actionable control signals or instructions. For example, control signals may instruct the rig to adjust drilling parameters such as weight on bit (WOB), rate of penetration (ROP), drilling fluid density, or rotation speed. In further examples, control signals may trigger safety protocols, such as modulating choke valves, initiating gas-handling systems, or verifying ignition sources at the flare stack. In aspects of the technology, the control signals may also be used to update or refine geological maps generated by map feature application 124, thereby integrating real-time drilling data with subsurface models or drilling model. In this manner, calculation and control generation engine 310 functions as the operative link between flare image analysis and active rig operations, ensuring timely and data-driven responses to changing wellbore conditions. Additional/alternative examples of Attributes, determination, and outputs are discussed with reference to FIG. 6.

In map feature application 124, feature determination engine 324 may determine features of the wellbore based on the received data from flare detection application 118. In some examples, feature determination engine 324 receives determinations and attributes output by classification engine 308 and calculation and control generation engine 310, and correlates those outputs with depth and positional data to identify wellbore features. The features may include, without limitation, faults, fractures, stratigraphic boundaries, high-pressure zones, and productive reservoir intervals. In further examples, the feature determination engine may utilize lag-time calculations of gas transport to the flare stack, along with operational parameters such as WOB, ROP, and downhole pressure, to refine the positional accuracy of the identified features. By fusing image-based determinations with operational data, the feature determination engine provides a robust dataset for generating accurate subsurface maps.

In aspects of the technology, GUI display engine 326 may produce a GUI display of some or all of the information of the updated map based on the determination of the wellbore features by feature determination engine 324. The GUI display engine 326 may present a real-time visualization of subterranean geological features, with overlays showing drill path, depth, and associated productivity indices. In some examples, the GUI may display color-coded representations of flare attributes, pressure gradients, or reservoir quality indicators, thereby allowing operators to rapidly interpret changing downhole conditions. The display may also include interactive elements that allow a user to adjust display layers (e.g., flare volume, gas composition, or drilling parameters) to tailor the map to specific operational needs. In aspects of the technology. GUI display engine 326 may provide time-stamped playback of map updates, enabling review of drilling progression and reservoir response over time.

In some examples, GUI display engine 326 displays data related to well productivity. In these examples, the GUI may show calculated indices of reservoir productivity, such as deliverability curves, flow-rate estimates, and inferred porosity or permeability values derived from flare image data and operational parameters. Productivity information may be displayed in both numerical and graphical formats, allowing operators to compare current well performance against expected benchmarks or offset wells. In aspects of the technology, the GUI display engine 326 may also provide predictive analytics, such as forecasted production rates or anticipated reservoir depletion profiles, generated by predictive models running within calculation and control generation engine 310. By integrating productivity data into the GUI, the system allows operators to make timely and informed decisions regarding drilling strategy, completion design, and reservoir management.

Updated wellbore feature information may be sent from map feature application 124 to rig control application 120 via communication channel 328.

In rig control application 120, MPD controller engine 316 may be used to control the pressure, fluid flow rate, temperature, or other variables within the wellbore during the drilling operation, using data received from one or more of flare detection application 118 using communication signal 312, and map feature application 124 via communication signal 328. Model update engine 318 may update the predictive model and control of wellbore pressures. In aspects of the technology, in a manner similar to that of FIG. 1, information may be sent from one or more of the flare detection application 118, rig control application 120 and map feature application 124 to the steering control application (not pictured) to update positioning of a drill for directional drilling.

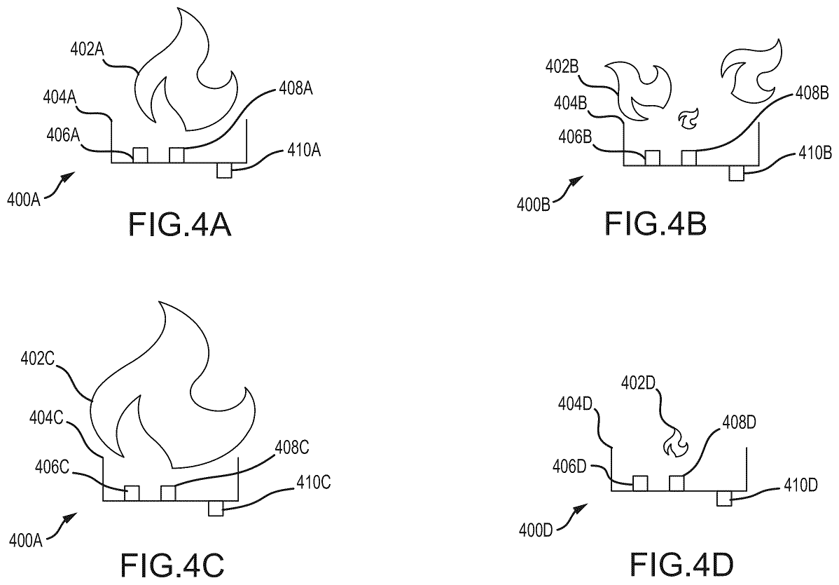

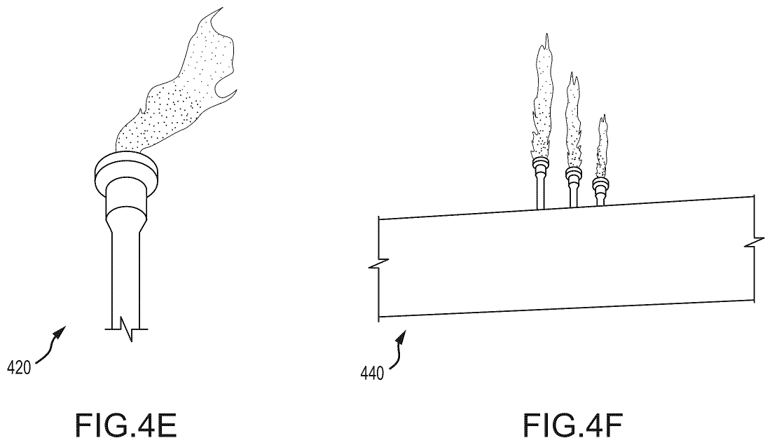

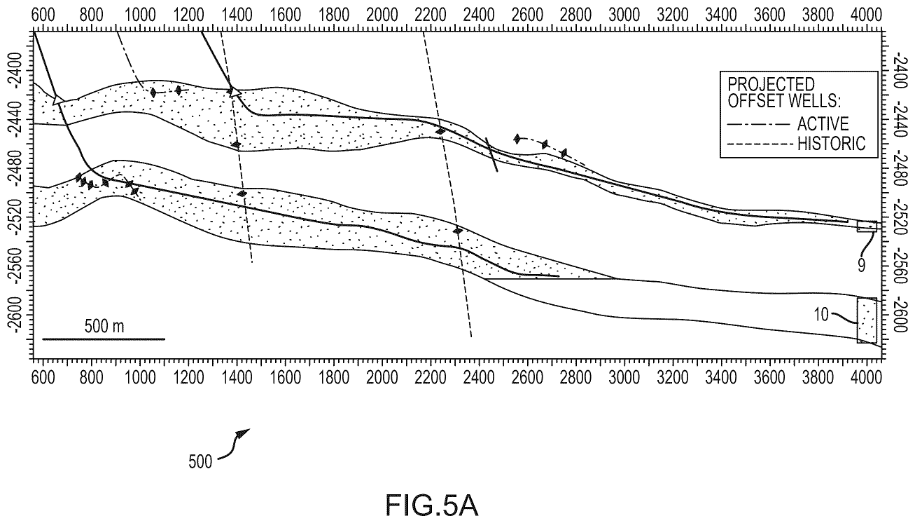

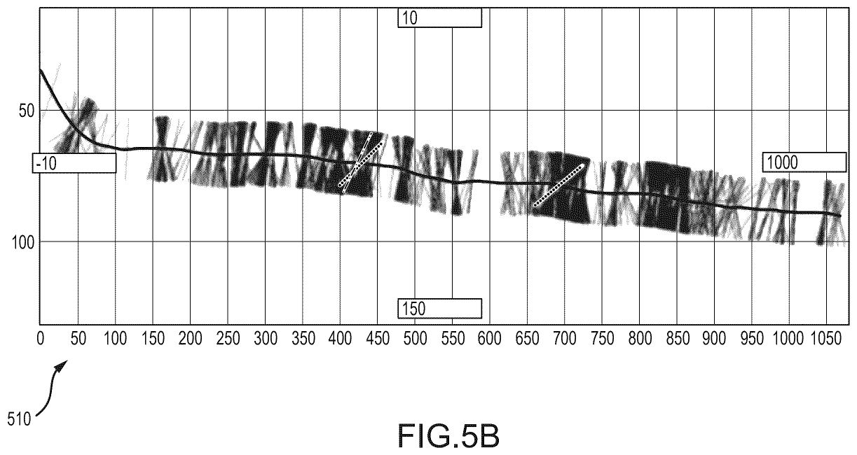

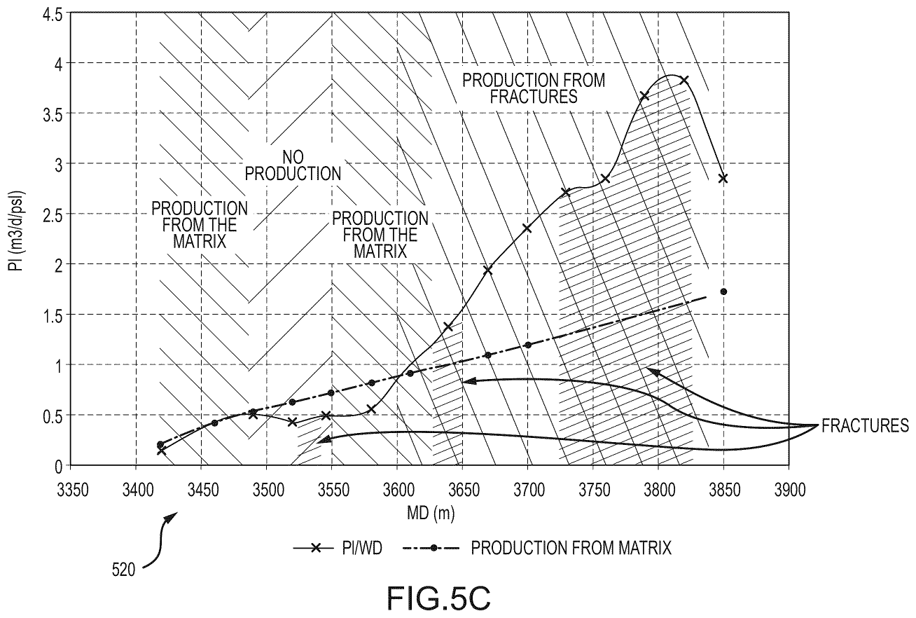

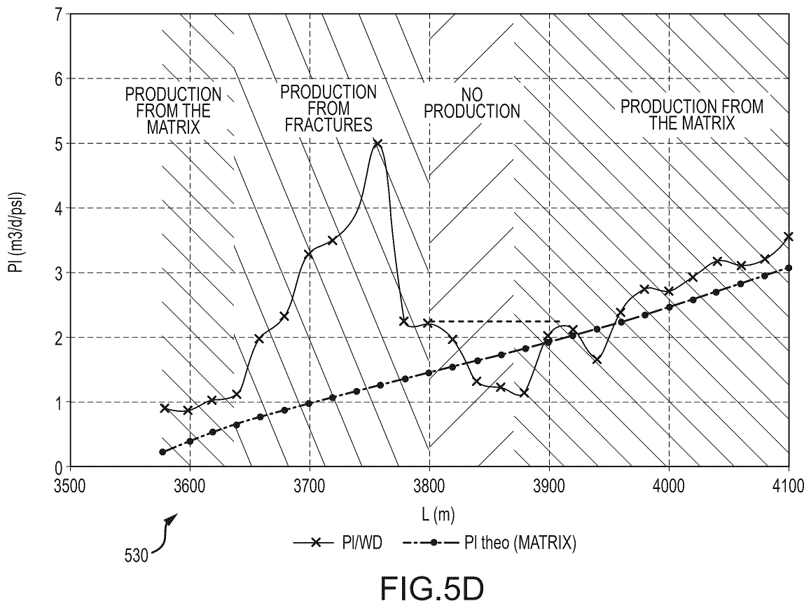

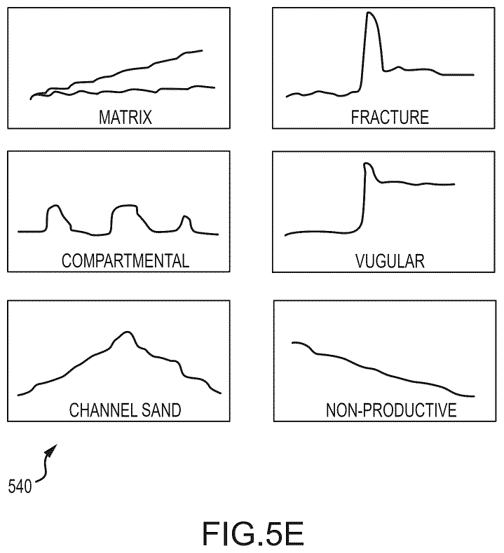

FIGS. 4A-4D illustrate example images of a flare stack 400A-D. As illustrated, the images of a flare stack may include the flare 402A-D, the wind shield 404A-D, the pilot burners 406A-D, the flare tip 408A-D and the ignition system 410A-D. Various example differences in the flare 402A-D are presented in each figure—optimal flame (402A of FIG. 4A), burning rain (402B of FIG. 4B), oversized or intense flame (402C of FIG. 4C) and small or no flame (402D of FIG. 4D). These and other images may be used to determine information before being sent to the map feature or rig control application. FIG. 4E-F illustrate example images of a flare stack using thermal imaging methodologies.

In some examples, the images of FIGS. 4A-4F may be processed by image tuning engine 304. Image tuning engine 304 may enhance or optimize raw images to improve clarity and consistency. Enhancements may include contrast adjustment, histogram equalization, deblurring, or normalization of lighting conditions. In certain examples, multiple sequential frames may be averaged, or super-resolution techniques applied, to generate pre-processed image data suitable for further analysis. This pre-processed image data provides a cleaner and more reliable input to subsequent engines.

In other examples, the images of FIGS. 4A-4F may be analyzed by flare attribute analysis engine 306. Flare attribute analysis engine 306 may identify one or more flare attributes from the images, including, without limitation, flame size, flame height, flame color, flame stability, or the presence of smoke. In aspects, thermal image data, such as in FIGS. 4E-4F, may also be used to determine additional attributes, such as combustion efficiency, heat distribution, or pilot burner performance. Each identified attribute may be associated with operational conditions, such as normal gas flow, incomplete combustion, increased permeability, or reduced flow. The attributes determined by analysis engine 306 may then be provided to determination and classification engine 308 for further processing.

FIGS. 5A-5E illustrate various graphical user interfaces (GUIs) and diagrams that may be generated as part of the mapping and productivity-while-drilling (PMWD) processes described herein, for example, as discussed in operations 1008 and 1408. FIG. 5A illustrates an example GUI 500 displaying positional information of various subterranean geological features as a visual map that may be produced using the systems and methods described herein. For example, the information determined from image data captured from a vision system may produce any of FIGS. 5A through 5E, as well as other useful information. FIGS. 5B-E illustrate example well productivity data as it may be displayed using some or all of the mapped data. As an example, FIG. 5A illustrates a GUI produced using some or all of the map data of subterranean geological features. FIG. 5B illustrates a structural cross section of a well path 510, displaying fracture concentrations. FIG. 5C illustrates example data of a PIWD diagram 520 displaying productivity index on the y-axis in m³/d/psi (“meters-cubed/day/pound per square inch”) and measured depth, in meters, on the x-axis. FIG. 5C includes information on the production of the well and information on fracture locations. FIG. 5D illustrates an additional example data of a PIWD diagram 530 displaying productivity index on the y-axis in m³/d/psi and length, in meters, on the x-axis. The image includes information on the production of the well and production from fractures. FIG. 5E illustrates example PIWD curves 540 that may be produced and displayed using a GUI.

FIG. 6 is a set of output instructions corresponding to an attribute determined from an image of a flare stack. As illustrated an attribute 602 leads to a determination 604 which leads to an output instruction 606. In some examples, the attribute is determined by a deep neural network (DNN). The DNN, for example, may be trained to analyze an image of a flare stack and determine an attribute. In aspects of the technology, the image of the flare stack is associated with a data stamp. In example 610, the attribute 602 is steady flame, the determination 604 is consistent flow of gas and normal drilling conditions and the output instruction 606 is no change in operational parameters. In example 612, the attribute 602 is pulsating flame, the determination 604 is fluctuations in gas flow, and the output instruction 606 is monitor pressure. In example 614, the attribute 602 is intense flame, the determination 604 is high-pressure zone with wider rock permeability and the output instruction 606 is adjust operational parameters and monitor well pressure. In example 616, the attribute 602 is smoke, the determination 604 is incomplete combustion and the output instruction 606 is check for liquid hydrocarbons. In example 618, the attribute 602 is flame color change, the determination 604 is gas composition change and the output instruction 606 is adjust flow rate and analyze gas. In example 620, the attribute 602 is no flame, the determination 604 may be one or more of no gas production, blockage, or ignition system failure and the output instruction 606 may be one or more of evaluate formation productivity, check for blockages, and check ignition system.

In aspects of the technology, evaluate formation productivity may include sending information to update or create a map of subterranean geological features. In certain examples, this may be or include sending well productivity data which may be displayed using a GUI. In certain aspects, the information may be identification of an unproductive area. This determination may be used to instruct the rig control to bypass the unproductive area during the other well operations, such as extraction and well completion.

In examples, adjust operational parameters may be one or more of direction (including inclination/azimuth), drilling rate, weight on bit (WOB), rotary speed, mud weight, flow rate of drilling fluid, temperature, pressure, torque, directional control, circulation pressure, and well control parameters. In a specific example, adjust operational parameters may be adjusting the flow restrictor. In aspects of the technology, gas handling procedures may include maintaining drill head position to maximize yield of a productive area. In certain aspects, gas handling procedures may include adjusting lateral positioning to steer a drill head to a productive area of a well.

In example 622, the attribute 602 may be sudden increase in flame size, the determination 604 may be increased permeability, and the output 606 may be one or both of adjust operational parameters and implement gas handling procedures. Each determination may rely on, in part, a flow of gas to the flare stack. Volume of such gas may be calculated using a choke point setting, a valve position controlling gas to flare stack, a pressure sensor measuring pressure in a line to a flare stack, and/or a measured flow rate of that gas in the line.

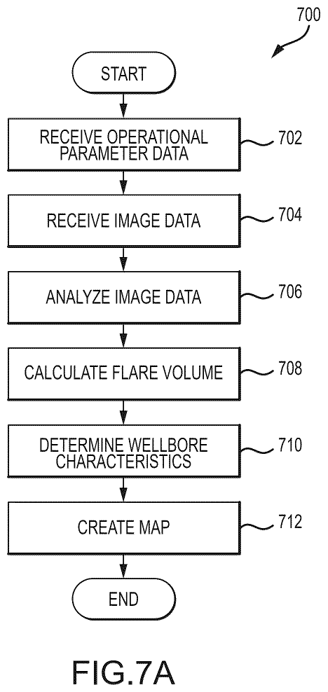

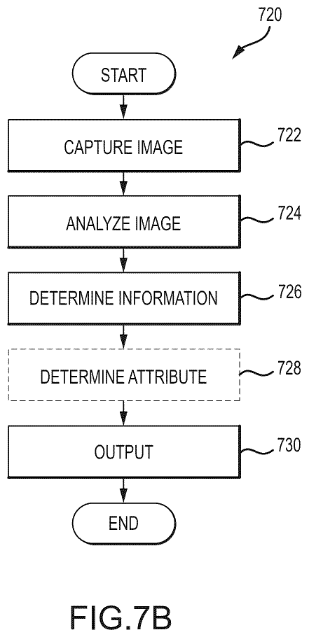

FIG. 7A is an example method 700 of creating a map using operational parameter data and image data. Method 700 begins with operation 702. In operation 702, operational parameter data is received. Examples of operational parameter data may include one or more of direction of drill, drill depth, fluid flow rate, downhole pressure, drill pipe pressure, WOB, ROP, fluid density, and drill speed. In a specific example, the operational parameter is drill depth.

Method 700 then proceeds to operation 704, receive image data. In examples, image data may be received suitable for input into a deep neural network (DNN). For example, image data may be captured in a digital format, typically as a matrix of pixel values. This matrix may represent the image in terms of its spatial dimensions (e.g., height and width) and color channels (e.g., RGB channels). To prepare the image data for processing by a DNN, the image may be resized to a predetermined fixed size, such as 224×224 pixels, to ensure consistency across all input images. The pixel values may then be normalized, typically by scaling them to a range between 0 and 1, or alternatively, to a range between −1 and 1. This normalization may enhance the performance and stability of the DNN during training and inference. Other pre-processing steps may be used as discussed herein.

After normalization, the image data may be converted to a grayscale format if the DNN is designed to process single-channel images. Alternatively, the image may retain its multi-channel format (e.g., RGB) if the DNN is configured to utilize color information. The preprocessed image may then be stored as a multi-dimensional array, or tensor, where each element corresponds to a pixel value in the image. The tensor format may typically include dimensions for the batch size, height, width, and number of color channels (e.g., [1, 224, 224, 3] for a single RGB image). This tensor representation allows, in examples, the image data to be efficiently processed by the layers of the DNN, facilitating tasks such as object recognition, image classification, or other forms of computer vision analysis.

Physical, chemical, mechanical, or other properties of the flare, flare stack, or surrounding environment may be translated into image data. In some examples, image data may include sensor data, including but not limited to one or more of acoustic data, temperature data, thermal radiation data, and pressure data. In aspects of the technology, the image data is an image of the flare.

Method 700 then proceeds to operation 706, analyze image data. In operation 706, the image data is analyzed. In examples, the image data is analyzed using a DNN. The DNN, for example, may have been trained to analyze the height, size, volume, color, or stability of the flare from the image data. In a specific example, the analysis of image data determines a flare height and size.

Method 700 then proceeds to operation 708, calculate flare volume. In operation 708, the volume of the flare is calculated from the analysis of the image data. In examples, the flare volume is calculated by a DNN. The DNN, for example, may have been trained to calculate the volume of a flare based on previous images of flares, having varied flare height and sizes that are known and tagged accordingly. In some examples, the flare volume may be larger than would be expected based on one or more of a map of subterranean geological features or operational parameter data. In aspects of the technology, the determined information of one or more of flare volume, height, or size may be used to automatically adjust the flow rate of gas to the surface.

Method 700 then proceeds to operation 710, determine wellbore features/geological feature. In operation 710, a wellbore feature and/or geological feature is determined. In some examples, the wellbore feature is determined by a DNN. The DNN, for example, may have been trained to determine the wellbore feature based on the image data. In a specific example, the wellbore feature is determined by having a tagged imaged data of a flare corresponding to the known wellbore feature.

Method 700 then proceeds to operation 712. In operation 712, a map is created by, at least in part, correlating the wellbore feature to a depth and or other positional information. In some examples, the map is created using information output by a DNN, such as the output information determined in operation 710. In examples, the map displays subterranean geological features. In other examples, wellbore productivity information may be associated with the map, such as positional information of a productive gas reservoir. In certain aspects, the productivity of the area (an expression of a reservoir's ability to deliver fluids to the wellbore) may be determined and displayed. In aspects of the technology, the map is updated to display subterranean geological features of areas surrounding the drill head location. In another example, the wellbore feature is, at least in part, determined by calculating the lag time for gas flow to reach the flare of the flare stack, and using the lag time to associate the image data with a depth or other positional information. In aspects of the technology, adjustments to operational parameters, such as WOB, ROP, fluid density, drill speed, mud motors, whipstock or bottom hole assembly may be performed based on the map. In examples, data reflected in the map is used to control directional drilling. In certain aspects, the data reflected in the map is used to target productive gas reservoirs.

FIG. 7B is an example method 720 of performing flare stack imaging and determining information. Method 720 begins with operation 722. In operation 722, an image of a flare stack is captured. In aspects, the image of a flare stack is a digital image of a flare stack, created using various means, including one or more of digital cameras, scanners, or digital imaging sensors. In aspects, the field of view is of the entire flare stack. In other aspects, the field of view is of the flare. In some aspects, an image capture device, is used to capture the image having image data. In aspects, the image is taken at an angle such as 80 degrees, 45 degrees, or other angle to the flare stack or flare. The captured image of a flare stack may include one or more of the flare, flare stack, and surrounding environment. In some examples, the image of the flare stack may be one or more of an image of combustion, flame, smoke, heat waves, soot, emission, the pilot flame, vapor, light, gas release, oil spray, pressure release, an intermittent or pulsating flare, a steady or continuous flare, or no flare/combustion.

Method 720 then proceeds to operation 724. In operation 724, the image of a flare stack is analyzed. In aspects of the technology, the image of a flare stack is analyzed using a DNN. The DNN, for example, may have been trained to output the size, color, or stability of the flare.

Method 720 then proceeds to determine information 726. In aspects of the technology, a data stamp, or the specific time that an image of the flare stack is captured, that may be but is not limited to a timer from the start of the process, time of day, time of day and date in DD/MM/YYYY format, day/hours/min/second time stamp, and/or measurement of the depth of the drill head, may be associated with the image of a flare stack. In aspects of the technology, the height of the flare, acoustic data, flow restrictor settings, positional information of the drill head, and calculated lag time are used to determine information related to one or more of the identity, location and productivity of a subterranean geological feature. In some examples, the determined information may be determined by a DNN. The DNN, for example, may be trained to determine a wellbore feature based on the input data (which may or may not be processed) of the image of a flare stack. In some examples, the determined information may be positional information of one or more subterranean geological features. The subterranean geological features may be one or more of faults, folds, natural fractures, induced fractures, natural fracture networks, induced fracture networks, stratigraphic boundaries, high-pressure zones, pressure transition zones, water-bearing zones, and reservoir zones. In a specific example, the determined information is a gas reservoir.

In some aspects of the technology, operation 728 may optionally be employed. In operation 728, the DNN may determine an attribute, such as a physical, chemical, mechanical, or other property of the flare, flare stack, or surrounding environment. The attribute may be associated with a data stamp of the image, including the time of the image capture. In some examples, the attribute may be a composition of gas. The gas may be composed of one or more of methane, ethane, propane, butane, hydrogen, hydrogen sulfide, carbon dioxide, nitrogen, benzene, toluene, ethylbenzenes, xylenes, methanol, and formaldehyde. In a specific example, the attribute is a composition of gas containing hydrogen, associated with a data stamp and determined subterranean geological feature. This information may be used to determine an increased release of hydrogen gas. One or more of the attribute and determined information may be used to determine the productivity of the subterranean geological feature (e.g., productivity may be an expression of a reservoir's ability to deliver fluids to the wellbore).

In further embodiments, the image data and associated environmental sensor data may be analyzed to calculate additional physical and chemical parameters of the flare, which are examples of attributes. This environmental data may form part of system 100 data as described above. For example, measurements of overall flare height, flame length, and width may be combined with environmental conditions to determine permeability on a per-section basis. Calculations may also include sizing of subsonic industrial flares according to allowable thermal radiation limits, including the contribution of solar radiation. Thermal radiation characteristics of both subsonic and sonic flares may be modeled, and corresponding noise levels may be determined. In addition, flue gas composition may be calculated or estimated from spectral or imaging data, allowing further refinement of wellbore productivity mapping and operational control.

In certain embodiments, the system may further comprise one or more environmental sensors in addition to the imaging device. These sensors provide information that may form part of the System 100 data described above. Such sensors may include thermal or radiation detectors (e.g., infrared radiometers, ultraviolet photodiodes, broadband radiometers, or pyranometers) configured to measure flare heat intensity and account for solar radiation contributions; acoustic sensors (e.g., microphones, acoustic pressure sensors, or vibration sensors) configured to characterize subsonic or sonic flare noise levels; gas analyzers (e.g., tunable diode laser absorption spectroscopy, Fourier-transform infrared analyzers, flame ionization detectors, electrochemical gas sensors, or portable mass spectrometry modules) configured to determine flue gas composition; and meteorological sensors (e.g., anemometers, barometers, hygrometers, or ambient temperature sensors) configured to measure environmental conditions surrounding the flare stack. Data from these sensors may be combined with image data to calculate flare radiation levels, noise intensity, and gas composition, as well as to apply environmental corrections to improve accuracy of wellbore productivity mapping and operational control.

Method 720 then proceeds to output operation 730. In operation 730, the determined information is stored or transmitted. For example, the determined information may be stored in a database. In another example, the determined information may be transmitted to the rig control application. The attribute of optional operation 728 may be stored or transmitted in output operation 730 if operation 728 was employed. In a specific example, the determined information of a gas reservoir and attribute of hydrogen gas may be reported to the rig control application. In an alternative example, the determined information of a gas reservoir, attribute of hydrogen gas, associated data stamp and positioning information may be stored in a database for future use.

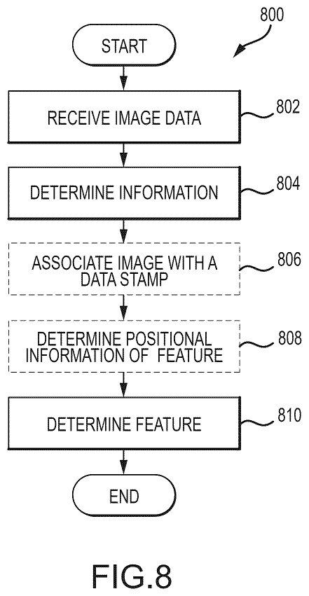

FIG. 8 is an example method 800 of determining subterranean geological features. Method 800 begins with receive image data 802. Image data may include physical, chemical, mechanical, or other properties of the flare, flare stack, or surrounding environment. In other examples, image data may include sensor data, including but not limited to one or more of acoustic data, temperature data, thermal radiation data, and pressure data. In aspects of the technology, the image data is an image of a flare stack. In a specific example, the image data is an image of the flare.

Method 800 then proceeds to operation 804. In operation 804, information may be determined based on the image of a flare stack. In aspects of the technology, information may be determined by a DNN. In some aspects, a DNN may determine the presence of one or more unexpected or unmapped subterranean geological features. In additional/alternative examples, the determined information is an attribute based on the image of a flare stack. In these examples, the attribute may be an attribute of the flare. Examples of flare attributes include, but are not limited to, flare size, flare height, flare consistency, and flare color. In certain aspects of the technology, no combustion or incomplete combustion may be determined. Example attributes of no combustion or incomplete combustion include, but are not limited to, oil spray, smoke, vapor, and soot. In certain aspects of the technology, the determined information may be based on acoustic, temperature or pressure sensors.

Method 800 then optionally proceeds to operation 806. In operation 806, the image data is associated with a data stamp, which may include the specific time that an image of the flare stack is captured, that may be, but is not limited, to a timer from the start of the process, time of day, time of day and date in DD/MM/YYYY format, or measurement of the depth of the drill head. In examples, the data stamp associated with the image is also associated with operational parameters, sensor data, and the like. For example, a flare stack choke valve positional information may also be associated with the data stamp. This may allow, in instances, to determine if the flare is relatively large in relationship to the position of the valve (e.g., valve nearly closed but flare relatively large). In this case the flare size determination or volume calculation may be used to compensate by the valve position restricting the flame size.

Method 800 then optionally proceeds to operation 808. In operation 808, the positional information of the subterranean geological feature is determined. In examples, the determined information is a wellbore feature. The wellbore feature may be positional information that includes depth and lateral positioning information. In examples, the positional information of the subterranean geological feature may be determined, at least in part, by calculating a transport delay lag time of a fluid and/or gas from a position of a drill head to the flare stack. In aspects of the technology, calculating the transport delay lag time involves operational drilling parameters related to the flow of gas to the flare stack. In examples, the productivity of the subterranean geological feature (an expression of a reservoir's ability to deliver fluids to the wellbore) is determined. In certain aspects, the productivity data may include calculations using the Brzustowski and Sommer approach. In some instances, a high-pressure region, low pressure region, high pressure region, etc., may be determined, in part, based on the positional information of a choke valve. For example, where a flare is relatively large, and the valve is in a partially closed position (e.g., 90% closed), it may be determined that the area of the well is high pressure and/or productive.

Method 800 then proceeds to operation 810. In operation 810, the identity of the subterranean geological feature is determined. Examples of subterranean geological features include but are not limited to faults, folds, natural fractures, induced fractures, natural fracture networks, induced fracture networks, stratigraphic boundaries, high-pressure zones, pressure transition zones, water-bearing zones, and reservoir zones. In aspects of the technology, the identity of the subterranean geological feature may be determined by a DNN. The DNN may, for example, be trained to determine the identity of a subterranean geological feature based on determined information of operation 804. In specific examples, the identity of the subterranean geological feature may be a hydrogen reservoir.

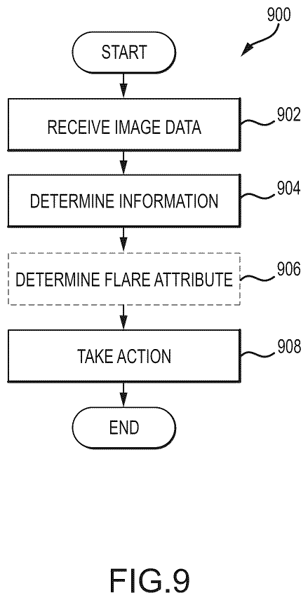

FIG. 9 is an example method 900 of taking action based on, at least in part, a determined information. Method 900 begins with receive image data operation 902. Image data may include physical, chemical, mechanical, or other properties of the flare, flare stack, or surrounding environment. In other examples, image data may include sensor data, including but not limited to one or more of acoustic data, temperature data and pressure data. In aspects of the technology, the image data is an image of a flare stack. In a specific example, the image data is an image of the flare.

Method 900 proceeds to determine information 904. In some aspects of the technology, a DNN may determine information based on the image of a flare stack. The DNN, for example, may be trained to determine the presence of one or more subterranean geological features. In certain aspects of the technology, the determined information may be the identity and/or positional information of one or more subterranean geological features. In other aspects of the technology, the determined information may be associated with a data stamp of the image data. In certain aspects of the technology, the determined information may be based on data received from acoustic, temperature, or pressure sensors. In examples, the determined information may be a wellbore feature. In aspects of the technology, the wellbore features may include positional information, such as drill depth and lateral positioning.

Method 900 optionally proceeds to operation 906. In operation 906, a DNN may determine an attribute of the flare based on the image of a flare stack. In aspects of the technology, the attribute may be one of flame size, flame color, or flame stability. In examples, the attribute may be one or more of a steady flame, a pulsating flame, an intense flame, a sudden increase in flame size, flame color change, smoke, oil spray, vapor, soot, and/or gas release. In examples, the gas release may be a gas composed of one or more of methane, ethane, propane, butane, hydrogen, hydrogen sulfide, carbon dioxide, nitrogen, benzene toluene, ethylbenzene, xylenes, methanol, and formaldehyde. In a specific example, the gas may be a composition containing hydrogen.

Method 900 then proceeds to operation 908. In operation 908, an action is taken based on one or more of the determined information and optionally determined flare attribute. In aspects of the technology, the action taken is to adjust operational parameters. Example operational parameter adjustments include adjusting ROP, WOB, rotary speed, mud flow rate, mud weight, a valve, or pump speed. In certain aspects of the technology, take action operation 908 includes mapping the subterranean geological features. This may include associating an identified subterranean geological feature with positional information based on the determined information. Examples of subterranean geological features include but are not limited to faults, folds, natural fractures, induced fractures, natural fracture networks, induced fracture networks, stratigraphic boundaries, high-pressure zones, pressure transition zones, water-bearing zones, or reservoir zones. In aspects of the technology, the take action step may be changing an operational parameter during well production based on the determined subterranean geological feature or features. In examples, the take action step may be to maintain drill head position at a productive subterranean geological feature, adjust the positioning of the drill head to return to a productive subterranean geological feature, or adjust operational parameters to bypass an unproductive subterranean geological feature or region. In certain aspects, the take action step may be calculating the productivity of a subterranean geological feature. In aspects of the technology, the action taken is to send one or more of an alert or an event notification. In examples, one or more of the determined information and optionally determined flare attribute may be compared to cuttings analyzed at a shaker table or mechanical mud separation machine.

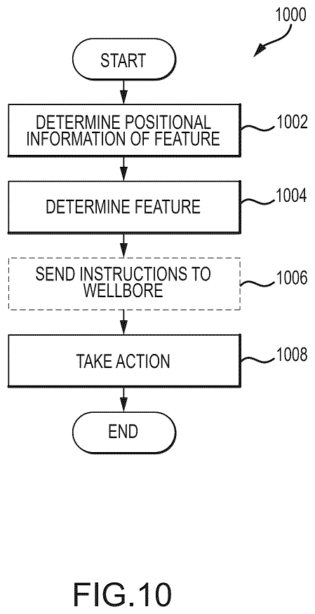

FIG. 10 is an example method 1000 of taking action based on, at least in part, a determined subterranean geological feature, such as a geological feature determined in operation 710 of method 700 or operation 1406 of method 1400. Method 1000 begins with operation 1002. In operation 1002, the positional information of a subterranean geological feature is determined. In examples, the positional information of the subterranean geological feature may be determined, at least in part, by calculating a transport delay lag time of a fluid from a position of a drill head to the flare stack. In aspects of the technology, the positional information includes depth and lateral positioning information.

Method 1000 then proceeds to operation 1004. In operation 1004, the identity of the subterranean geological feature is determined. The subterranean geological feature may be determined as, for example, a fault, fold, natural fracture, induced fracture, natural fracture network, induced fracture network, stratigraphic boundary, high-pressure zone, pressure transition zone, water-bearing zone, or reservoir zone. In aspects of the technology, operation 1004 may be determined using a DNN. The DNN may, for example, be trained to determine the identity of a subterranean geological feature based on, at least in part, received image data.

Method 1000 then optionally proceeds to operation 1006. In operation 1006, instructions are sent to the wellbore. For example, instructions sent to the wellbore may be adjustments to operational parameters, including, adjusting ROP, WOB, rotary speed, mud flow rate, mud weight, a valve, and pump speed. In aspects of the technology, instructions may be control instructions to steer a drill based on the map. In certain aspects of the technology, the instructions include an azmuithal, wherein the azmuithal directs at least a portion of the BHA towards a wellbore feature.

Method 1000 then proceeds operation to 1008. In operation 1008, an action is taken. In some aspects of the technology, the action is to adjust operational parameters of the wellbore or drill rig. For example, the action may be one of adjusting a ROP, adjusting WOB, adjusting rotary speed, adjusting mud flow rate, adjusting mud weight, actuating a valve, or changing a pump speed. In aspects of technology, taking action may include one or more of generating an alert and an event notification. In aspects of the technology, take action operation 1008 may include generating a map of the subterranean geological features. Examples of subterranean geological features include but are not limited to faults, folds, natural fractures, induced fractures, natural fracture networks, induced fracture networks, stratigraphic boundaries, high-pressure zones, pressure transition zones, water-bearing zones, or reservoir zones. In aspects of the technology, the take action step may be changing an operational parameter during well production based on the determined subterranean geological feature or features. In certain examples, the take action step may be to maintain drill head position at a productive subterranean geological feature, adjust the positioning of the drill head to return to a productive subterranean geological feature, or adjust operational parameters to bypass an unproductive subterranean geological feature or region. In certain aspects, the take action step may be calculating the productivity of the determined subterranean geological feature. In aspects of the technology, the determined information may be compared to cuttings analyzed at a shaker table or mechanical mud separation machine. In aspects of the technology, the take action step may be changing an operational parameter during well completion and or drilling model update based on the determined subterranean geological feature or features.

It will be appreciated that operation 1008 may also include generating a map of subterranean geological features. In aspects of the technology, such a map may be built from image data, System 100 data, and inferred geological features identified by the deep neural network. Building a map is further discussed with reference to operation 1408 of method 1400, and in examples, a graphical user interface may be output representing the map data as discussed with reference to FIGS. 5A-5E. Building a productivity-while-drilling (PMWD) map provides additional benefits by enabling the completions team to more precisely place tools necessary to produce the well. For example, perforations, sliding sleeves, and stimulation jobs such as fracking or acidizing may be optimized using the productivity map. In aspects of the technology, productivity zones may also be detected by analyzing the amount of energy expended at the flare during drilling operations. Mapping high- and low-productivity zones in this manner provides operators with insight into the heterogeneity of the wellbore. In some examples, by avoiding areas of depletion or zones of very high conductivity either during completion or in adjacent drilling operations, negative interactions may be significantly reduced or avoided altogether. In further aspects, drilling models for wells in the same geographic area may be updated by comparing the current productivity map against expected results, thereby improving accuracy of future drilling predictions and well placement.

Additionally, the take action operation 1008 may also include generating and displaying completion-related instructions as part of the graphical user interface. For example, based on the map of subterranean geological features, the system may present display indicators suggesting well completion operations such as placement of perforations, selection of sliding sleeves, or planning of stimulation treatments including fracking or acidizing. These instructions may be displayed alongside other operational recommendations such as adjusting weight on bit, rate of penetration, fluid density, drill speed, use of a mud motor, setting of a whipstock, updating a drilling model, or modifying a bottom hole assembly.

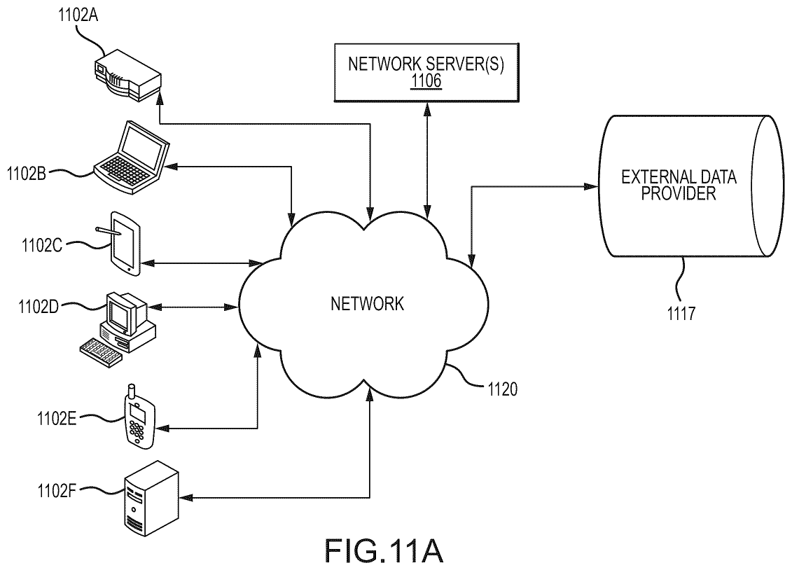

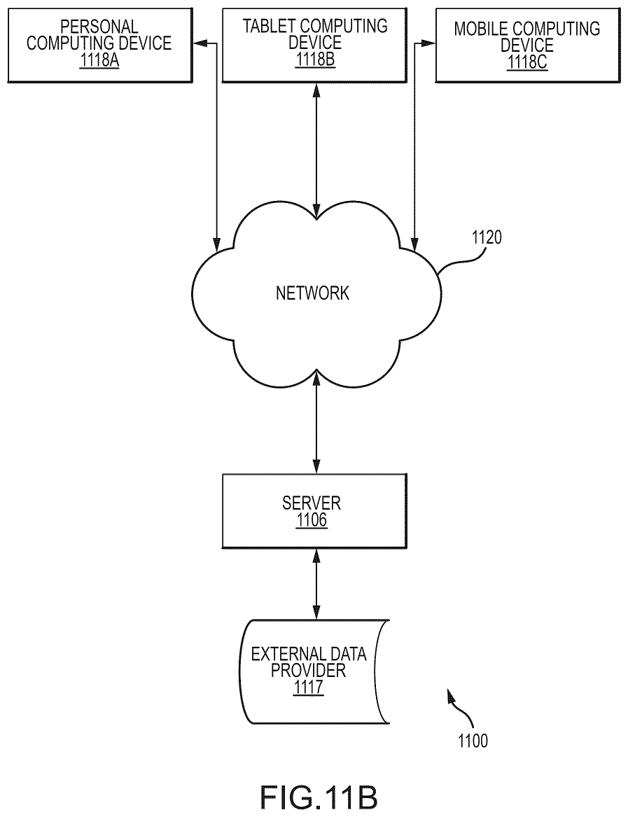

FIG. 11A is an example diagram of a distributed computing system in which aspects of the present invention may be practiced. According to examples, any computing devices, such as a modem 1102A, a laptop computer 1102B, a tablet 1102C, a personal computer 1102D, a smartphone 1102E, and a server 1102F, may contain engines, components, etc., for controlling the various equipment associated with image capture and detection. Additionally, according to aspects discussed herein, any of the computing devices may contain the necessary hardware for implementing aspects of the disclosure. Any and/or all of these functions may be performed, by way of example, at network servers 1106 and/or when computing devices request or receive data from external data providers 1117 by way of a network 1120.

FIG. 11B is one embodiment of the architecture system 1100 in which aspects of the present disclosure may be practiced. Content and/or data interacted with, requested, and/or edited in association with one or computing devices may be stored in different communication channels or other storage types. For example, data may be stored using a directory service, a web portal, a mailbox service, an instant messaging store, or a compiled networking service for image detection and classification. The distributed computing system 1100 may be used for running the various engines to perform image capture and detection. The computing devices 1118A, 1118B, and/or 1118C may provide a request to a cloud/network 1120, which is then processed by a network server 1106 in communication with an external data provider 1117. By way of example, a client computing device may be implemented as any of the systems described herein and embodied in the personal computing device 1118A, the tablet computing device 1118B, and/or the mobile computing device 1118C (e.g., a smartphone).

Any of these aspects of the systems described herein may obtain content from the external data provider 1117.

In various examples, the types of networks used for communication between the computing devices that make up the present invention include but are not limited to, the Internet, an intranet, wide area networks (WAN), local area networks (LAN), virtual private networks (VPN), GPS devices, SONAR devices, cellular networks, and additional satellite-based data providers such as the Iridium satellite constellation which provides voice and data coverage to satellite phones, pagers, and integrated transceivers, etc. According to aspects of the present disclosure, the networks may include an enterprise network and a network through which a client computing device may access an enterprise network. According to additional aspects, a client network is a separate network accessing an enterprise network through externally available entry points, such as a gateway, a remote access protocol, or a public or private Internet address.

Additionally, the logical operations may be implemented as algorithms in software, firmware, analog/digital circuitry, and/or any combination thereof, without deviating from the scope of the present disclosure. The software, firmware, or similar sequence of computer instructions may be encoded and stored upon a computer-readable storage medium. The software, firmware, or similar sequence of computer instructions may also be encoded within a carrier-wave signal for transmission between computing devices.

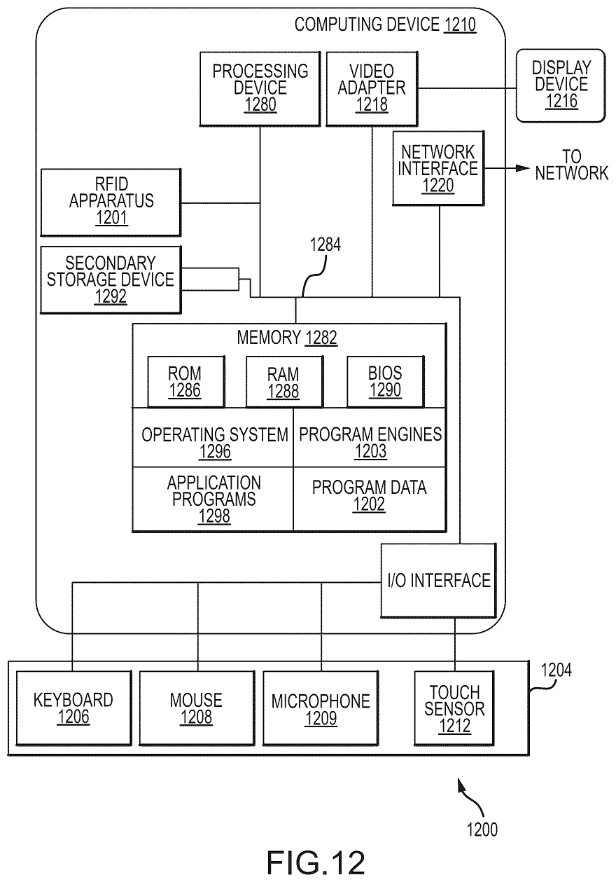

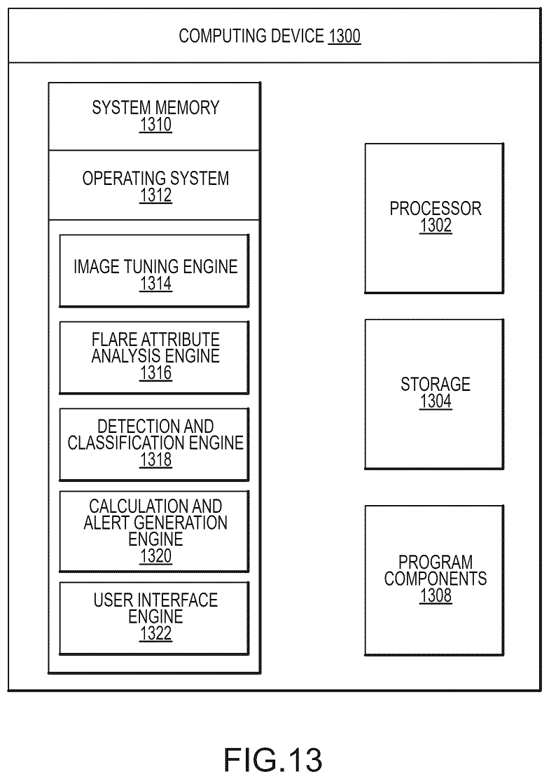

FIG. 12 illustrates an exemplary architecture of a computing device 1210 that can be used to implement aspects of the present disclosure. Operating environment 1200 typically includes at least some form of computer-readable media. Computer-readable media can be any available media that can be accessed by a processor such as processing device 1280 depicted in FIG. 12 and processor 1302 shown in FIG. 13 or other devices comprising the operating environment 1200. By way of example, and not limitation, computer-readable media may comprise computer storage media and communication media.

Computer storage media includes volatile and nonvolatile, and removable and non-removable media implemented in any method or technology for storage of information such as computer-readable instructions, data structures, program engines, or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer-readable instructions, data structures, program engines, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

The operating environment 1200 may be a single computer operating in a networked environment using logical connections to one or more remote computers. The remote computer may be a personal computer, a GPS device, a monitoring device such as a static-monitoring device or a mobile monitoring device, a pod, a mobile deployment device, a server, a router, a network PC, a peer device, or other common network nodes, and typically includes many or all of the elements described above as well as others not so mentioned. The logical connections may include any method supported by available communications media. Such networking environments are commonplace in enterprise-wide computer networks, intranets, and the Internet.

FIG. 13 is a block diagram illustrating additional physical components (e.g. hardware) of a computing device 1300 with which certain aspects of the disclosure may be practiced. Computing device 1300 may perform these functions alone or in combination with a distributed computing network such as those described with regard to FIGS. 1A and 11B which may be in operative contact with personal computing device 1118A, tablet computing device 1118B, and/or mobile computing device 1118C which may communicate and process one or more of the program engines described herein.

In a basic configuration, the computing device 1300 may include at least one processor 1302 and a system memory 1310. Depending on the configuration and type of computing device, the system memory 1310 may comprise, but is not limited to, volatile storage (e.g., random access memory), non-volatile storage (e.g., read-only memory), flash memory, or any combination of such memories. The system memory 1310 may include an operating system 1312 and one or more program engines, such as engines 1314, 1316, 1318, 1320, and 1322. The operating system 1312, for example, may be suitable for controlling the operation of the computing device 1300. Furthermore, aspects of the disclosure may be practiced in conjunction with a graphics library, other operating systems, or any other application program and are not limited to any particular application or system.

The computing device 1300 may have additional features or functionality. For example, the computing device 1300 may also include an additional data storage device (removable and/or non-removable) such as, for example, magnetic disks, optical disks, or tape. Such additional storage is illustrated in FIG. 13 by storage 1304. It will be well understood by those of skill in the art that storage may also occur via the distributed computing networks described in FIG. 11A and FIG. 11B. For example, the computing device 1300 may communicate via network 1120 in FIG. 11A and data may be stored within network servers 1106 and transmitted back to computing device 1300 via network 1120 if it is determined that such stored data is necessary to execute one or more functions described herein. Additionally, computing device 1300 may communicate via network 1120 in FIG. 11B and data may be stored within network server 1106 and transmitted back to computing device 1300 via a network, such as network 1120, if it is determined that such stored data is necessary to execute one or more functions described herein.

As stated above, a number of program engines and data files may be stored in the system memory 1310. While executing the at least one processor 1302, the program engines 1314, 1316, 1318, 1320, and 1322 (e.g., the engines described with reference to FIG. 3) may perform processes including, but not limited to, the aspects described herein.

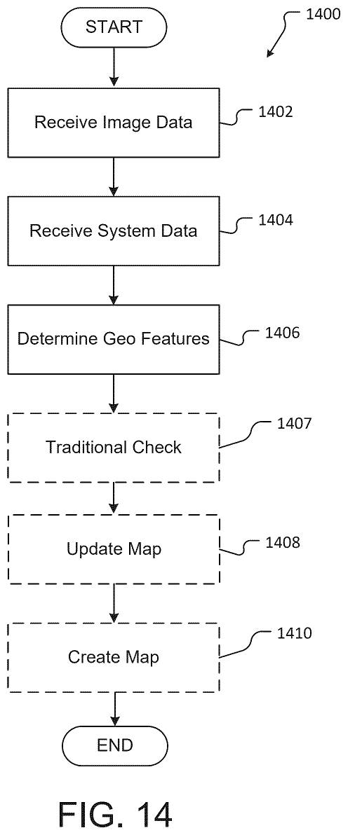

FIG. 14 provides an additional method 1400 for determining and mapping subterranean geological features. Method 1400 begins with operation 1402, receive image data. In operation 1402, an image of a flare stack is captured and received. The image may include the flare, flare stack column, and surrounding environment and may be captured in visible, infrared, thermal, multispectral, or other bands, optionally pre-processed (e.g., resizing, normalization, denoising) as described elsewhere herein. In some examples, thermal frames and/or multispectral frames are included to capture flame radiance, color, and stability signatures indicative of combustion chemistry and volume.

Method 1400 then proceeds to operation 1404, receive System 100 data. In examples, System 100 data is received contemporaneously or proximate in time with the image. System 100 data may include, without limitation: drill direction/inclination/azimuth, measured depth/true vertical depth, rate of penetration (ROP), weight on bit (WOB), rotary speed, drilling fluid density and rheology, mud flow rate, downhole and drill-pipe pressures, choke/valve position settings to the flare (flare output choke setting), flow restrictor settings, surface and downhole temperature, torque, MWD/LWD measurements, acoustic data, thermal radiation data, gas analyzer outputs (e.g., TDLAS, FTIR, FID, electrochemical, mass spectrometry, gas chromatography), meteorological data (wind speed/direction, barometric pressure, humidity, ambient temperature), and positional information of the drill head and BHA. These parameters are non-limiting examples of System 100 data previously described and may be time-stamped for fusion with image frames.

Method 1400 then proceeds to determine geological features using a DNN. In operation 1406, a deep neural network (DNN) receives (i) the pre-processed image data from operation 1402 and (ii) a synchronized feature vector derived from System 100 data received in operation 1404. The network outputs a predicted subterranean geological feature and, in some examples, a corresponding positional estimate (e.g., depth index and/or lateral offset), confidence scores, and productivity indicators.

By way of example, a convolutional backbone (e.g., a convolutional neural network (CNN)) encodes spatial features from the image(s), such as flame height, width, intermittency, color temperature proxies, and plume morphology. In parallel, a temporal encoder (e.g., a gated recurrent unit (GRU), a long short-term memory (LSTM) network, or a one-dimensional convolutional (1-D conv) network) is configured to model time-varying trends in the System 100 data, capturing patterns in ROP, pressure fluctuations, choke position, and flow rate. The encoded image features and encoded System 100 features are then concatenated and passed to a fusion head (e.g., an attention module or a multilayer perceptron) that outputs both classification results (e.g., fracture, fault, stratigraphic boundary, high-pressure/transition zone, reservoir interval) and regression results (e.g., predicted depth/lateral offset, productivity index).

Other means of providing the image data and System 100 data to the DNN may also be used. For example, the data may be imported through alternative preprocessing pipelines, feature extractors, or data encoders, and may be supplied to the DNN either separately, in parallel streams, or as a combined fused input. In some embodiments, the image data and System 100 data are formatted into a single multi-modal tensor, while in other embodiments each data type is processed independently and subsequently merged at one or more layers of the network.

In examples, flare morphology (from the image) correlates with surface gas release dynamics; choke setting and line pressure (from System 100) disambiguate whether an enlarged flame is due to subsurface permeability or surface control changes; ROP/WOB and downhole pressure help distinguish formation-caused flow spikes from operational events; acoustic signatures (e.g., sonic roar of high-velocity flow) and thermal radiation refine intensity estimates; gas composition signals (e.g., hydrogen, heavier hydrocarbons) further condition the geological inference. The DNN learns these joint patterns from labeled examples where geological features are known.

To estimate the positional depth associated with an image-derived event, the system may compute a transport delay lag between the drill bit location at time t and the flare response observed at time t+Δt. At may be estimated from annular flow velocity, mud properties, and circulation model parameters and/or learned by the DNN as an auxiliary output. The predicted feature is, in examples, then shifted back along the drilling timeline by Δt and associated with the bit depth at time t. Valve/choke position may also be used as a corrective factor when back-projecting the signal to depth (e.g., large flame with nearly closed choke suggests unusually high reservoir pressure/permeability at the originating interval).

In some embodiments, the DNN also outputs a productivity index or permeability class (e.g., in millidarcies, mD). In examples, the DNN learns to map combinations of (flare apparent volume/intensity, spectral/thermal cues) and (flow/choke/pressure) to permeability classes, optionally calibrated against offset well tests and PIWD curves. This provides a continuous or categorical estimate of local reservoir quality.

Method 1400 then optionally proceeds to operation 1407, perform a traditional check. In operation 1407, traditional engineering calculations are used to validate or corroborate the geological features predicted by the DNN. For example, the lag time and valve choke position (and other System 100 Data, such as down hole pressure, temperature) may be used to calculate expected flare size and volume, which may then be compared to the flare attributes inferred by the DNN.

In examples, if the DNN predicts a high-pressure zone, the system may confirm that the calculated flare volume (based on choke setting and measured line pressure) is consistent with such a condition. Similarly, if the DNN predicts a fault or fracture network, the system may cross-check for increased mud losses, higher than expected gas-cut mud returns, or abnormal pressure transitions. In another example, if a reservoir interval is predicted, the system may check for correlation with higher permeability values calculated from conventional inflow performance relationships.

It will be appreciated that various outputs may be checked using traditional methods. For example, flare volume may be estimated using standard engineering calculations based on valve coefficient, choke area, pressure differential, and fluid density, as is known in the art. Further, transport delay lag may be calculated using conventional circulation models that relate annular flow velocity, fluid properties, and well depth to the time for gases to reach the surface. Permeability may be estimated using Darcy-based relationships that relate flow rate, pressure differential, fluid viscosity, and formation properties. Productivity index may be calculated from established inflow performance relationships using measured flow rates and drawdown pressures. It will be appreciated that methods for estimating flare volume, transport lag, permeability, productivity, and other geological features now known or later developed may be implemented herein without departing from the scope of the innovative technologies described herein.

These traditional calculations may be compared against the DNN outputs to assess logical consistency. In aspects of the technology, a significant mismatch may trigger an alert or may output a GUI change indicating low confidence.

The method optionally proceeds to operation 1408, create or update a map. Using the predicted geological feature identities, their lag-corrected depths (and optionally lateral offsets), and confidence scores, the system creates or updates a map of subterranean geological features. The GUI may overlay the well path with flagged intervals (e.g., fractures, faults, reservoir zones), color-coded by predicted productivity class or gas composition. The map may be updated in near-real-time as drilling progresses and may be forwarded to rig control and steering applications for operational adjustments (e.g., maintain or return to productive zones; bypass unproductive intervals; adjust WOB/ROP/mud weight; steer laterally along a productive horizon). These maps may be similar to or the same as the ones shown with reference to FIGS. 5A-5E.

In aspects of the technology, the transport delay lag assists in the creation of the map. The transport delay lag compensates for the time it takes fluids and entrained gases to travel from the downhole interval to the surface/flare. In examples, the map service applies the lag model (and DNN residual correction) to time-stamp shifts before writing intervals to depth.

In aspects of the technology, the traditional method may be employed to directly estimate flare size, flare volume, or reservoir characteristics without use of the deep neural network. For example, valve choke setting and measured line pressure may be used to calculate flare volume, transport delay lag may be used to correlate flare events to drill depth, and Darcy-based calculations may be used to estimate permeability or productivity index values. These direct calculations may serve as an alternative to, or operate in parallel with, the DNN-based determinations, thereby providing redundant or corroborative pathways for identifying subterranean geological features.

Method 1400 then optionally proceeds to operation 1410, take action. For example, in operation 1410, the subterranean geological feature information or map information generated in operation 1408 may be used to provide control instructions to a drill rig. In examples, the control instructions adjust one or more operational parameters, such as azimuth, inclination, or weight on bit, to steer the bottom hole assembly toward a productive reservoir interval or fracture network identified by the deep neural network. Conversely, if an unproductive zone, high-pressure transition, or water-bearing interval is identified, the control instructions may adjust the trajectory of the drill bit away from that zone to reduce risk and improve drilling efficiency.

In aspects of the technology, the map may integrate lag-corrected feature depth, lateral positioning, and productivity indices, and may be transmitted to a rig control or steering application. In examples, the steering application uses the map to plan real-time corrections, such as maintaining the drill path within a productive layer or returning the drill bit to a previously bypassed high-yield interval. These adjustments may be performed automatically by a control system or presented to an operator through a graphical user interface, thereby providing actionable guidance to optimize wellbore placement, maximize reservoir contact, and enhance overall production. Other actions may be taken, such as some or all of the actions referenced with respect to operation 1008 of method 1000.

While various embodiments and examples have been described for purposes of this disclosure, various changes and modifications may be made that are well within the scope of the disclosed methods. Numerous other changes may be made which will readily suggest themselves to those skilled in the art and which are encompassed in the spirit of the disclosure.

It will be clear that the systems and methods described herein are well adapted to attain the ends and advantages mentioned as well as those inherent therein. Those skilled in the art will recognize that the methods and systems within this specification may be implemented in many manners and as such, is not to be limited by the foregoing exemplified embodiments and examples. In other words, functional elements being performed by a single or multiple components, and individual functions can be distributed among different components. In this regard, any number of the features of the different embodiments described herein may be combined into one single embodiment, and alternate embodiments having fewer than or more than all of the features herein described as possible.

What is claimed:

1. A computer-implemented method for analyzing flare stack images, the method comprising:
receiving drill rig operational parameters comprising at least one of a direction, a drill depth, a fluid flow rate, a downhole pressure, and a drill pipe pressure;
receiving image data from a flare stack;
analyzing the image data to determine a flare height and size;
calculating an estimated volume of the flare based on at least the image data;
based on at least one of a flare height, size, and estimated volume, determining a wellbore feature; and
correlating the wellbore characteristic to a depth to create a map.

2. The computer-implemented method of claim 1, wherein correlating the wellbore feature comprises calculating at least one of the group consisting of (1) a transport delay lag between the imaged flare and the depth and (2) a flare output choke setting, and wherein calculating the transport delay lag comprises determining operational drilling parameters related to the flow of gas to the flare stack.

3. The computer-implemented method of claim 1, further comprising:
calculating and displaying wellbore productivity information based on, at least in part, the map; and
based on the map, adjusting one of a weight on bit, a rate of penetration, a fluid density, a drill speed, a mud motor, a whipstock, a well completion output instruction, and a drilling model, or a bottom hole assembly.

4. The computer-implemented method of claim 1, further comprising automatically adjusting the flow rate of gas to the surface based on at least one of a flare height, size, and estimated volume.

5. The computer-implemented method of claim 1, wherein analyzing the image data comprises using a deep neural network.

6. The computer-implemented method of claim 1, wherein receiving image data from a flare stack includes receiving sensor data, the sensor data comprising one or more of:
acoustic data, temperature data, and pressure data.

7. The computer-implemented method of claim 1, further comprising:
sending data from the map to control directional drilling; and
using the map to target productive gas reservoirs.

8. A computer-implemented method comprising:
capturing an image of a flare stack;
determining a wellbore feature based on the image of a flare stack; and
taking an action based on the determining information operation.

9. The computer-implemented method of claim 8, wherein determining the wellbore feature based on the image of a flare stack comprises:
determining, by Deep Neural Network (“DNN”), an attribute based on the image of a flare stack; and
associating the image of a flare stack with a data stamp.

10. The computer-implemented method of claim 8, wherein determining the wellbore feature comprises determining positional information of at least one subterranean geological feature, wherein the positional information is determined in part from the image of the flare stack and at least one of a transport delay lag and a flare valve choke setting.

11. The computer-implemented method of claim 10, further comprising using the positional information to generate a map of the at least one subterranean geological feature with depth and lateral positioning information.

12. The method of claim 11, wherein the positional information of the at least one subterranean geological feature is determined, at least in part, by calculating a transport delay lag time of a fluid from a position of a drill head to the flare stack.

13. The method of claim 10, wherein the at least one subterranean geological feature includes at least one of:
fault, fold, natural fracture, induced fracture, natural fracture network, induced fracture network, stratigraphic boundary, high-pressure zone, pressure transition zone, water-bearing zone, hydrogen reservoir, or reservoir zone.

14. The computer-implemented method of claim 10, wherein taking the action comprises sending instructions to change an operational parameter during well production based on the at least one subterranean geological feature.

15. The computer-implemented method of claim 8, wherein taking the action comprises:
sending instructions to change an operational parameter during wellbore drilling, wherein the operational parameter is at least one selected from the group consisting of:
adjusting a rate of penetration, adjusting weight on bit, adjusting rotary speed, adjusting mud flow rate, adjusting mud weight, actuating a valve, or changing a pump speed.

16. The computer-implemented method of claim 8, wherein the image of a flare stack comprises:
an image of combustion, flame, smoke, heat waves, soot, emission, pilot flame, vapor, light, gas release, oil spray, pressure release, intermittent flare, or continuous flare.

17. The computer-implemented method of claim 9, wherein the attribute is a composition of at least one gas emanating from the flare stack at the data stamp, wherein the composition of at least one gas is one or more selected from the group consisting of:
methane, ethane, propane, butane, hydrogen, hydrogen sulfide, carbon dioxide, nitrogen, benzene, toluene, ethylbenzene, xylenes, methanol, and formaldehyde;
and further wherein the composition of the gas is indicated on subterranean map based in part on a transport delay lag.

18. The computer-implemented method of claim 9, wherein the attribute is determined, at least in part, by sensor data captured from one or more sensors, wherein one or more sensors are selected from the group consisting: thermal radiation detectors, infrared radiometers, ultraviolet photodiodes, broadband radiometers, pyranometers, acoustic microphones, acoustic pressure sensors, vibration sensors, tunable diode laser absorption spectroscopy (TDLAS) analyzers, Fourier-transform infrared (FTIR) gas analyzers, flame ionization detectors, electrochemical gas sensors, mass spectrometry modules, gas chromatography units, anemometers, barometers, hygrometers, and ambient temperature sensors.

19. The computer-implemented method of claim 8, wherein taking action is at least one selected from the group consisting of:
generating one of an alert, generating an event notification, and sending control instructions to a steer a drill based on the information.

20. The computer-implemented method of claim 1, further comprising, sending control instructions to steer a drill based on the map, wherein the instructions include an azmuithal, wherein the azimuthal directs at least a portion of the BHA towards a wellbore feature.

21. A computer-implemented method for determining subterranean geological features, the method comprising:
receiving image data of a flare stack;
receiving data contemporaneous with the image data, the data comprises at least one of drill direction, drill depth, rate of penetration, weight on bit, rotary speed, drilling fluid density, drilling fluid flow rate, downhole pressure, drill pipe pressure, choke or valve position, acoustic data, thermal radiation data, gas composition data, or positional information of a drill head; and
inputting the image data and the data into a deep neural network to output a subterranean geological feature.

22. The method of claim 21, wherein the subterranean geological feature output by the deep neural network comprises at least one of a fracture, fault, stratigraphic boundary, high-pressure zone, pressure transition zone, or reservoir interval, and wherein the output further comprises a positional estimate, a confidence score, or a productivity index.

23. The method of claim 21, further comprising performing a traditional check to validate the subterranean geological feature, wherein the traditional check comprises at least one of: calculating flare volume from a choke valve setting and line pressure, calculating a transport delay lag, calculating permeability using Darcy's law, or calculating a productivity index.

24. The method of claim 21, further comprising creating or updating a map of subterranean geological features using the subterranean geological feature output by the deep neural network, wherein the map is adjusted using transport delay lag and transmitted to a rig control or steering application to modify one or more operational parameters.

25. The method of claim 24, further comprising:
calculating and displaying wellbore productivity information based on, at least in part, the map; and
based on the map, adjusting one of a weight on bit, a rate of penetration, a fluid density, a drill speed, a mud motor, a whipstock, a well completion output instruction, and a drilling model, or a bottom hole assembly.
